(19) United States
(12) Patent Application Publication
(10) Pub. No.: US 2006/0153037 A1
(43) Pub. Date: Jul. 13, 2006

(54) Information recording medium, recording apparatus and recording method for information recording medium, reproducing apparatus and reproducing method for information recording medium, computer program for controlling recording or reproduction, and data structure including control signal

(75) Inventors: Takeshi Koda, Saitama (JP); Masayoshi Yoshida, Saitama (JP); Keiji Katata, Saitma (JP)

Correspondence Address: YOUNG & THOMPSON, 745 SOUTH 23RD STREET, 2ND FLOOR, ARLINGTON, VA, 22202, US

(73) Assignee: PIONEER CORPORATION, Tokyo (JP)

(21) Appl. No.: 10/563,367

(22) PCT Filed: Apr. 19, 2004
(86) PCT No.: PCT/JP04/05530

§ 371 Date: Jan. 4, 2006

(30) Foreign Application Priority Data
Jul. 7, 2003 (JP) 2003-192951

(51) Int. Cl. G11B 19/04; G11B 27/36; G11B 20/18; G11B 11/105; G11B 7/00; G11B 7/09; G11B 11/03; G11B 11/11; G11B 11/115; G11B 11/12; G11B 15/04; G11B 5/58; G11B 7/095

(52) U.S. Cl. 369/53.21

(57) ABSTRACT

An information recording medium (100) provided with: a data area (108) to record therein record data; a spare area (109, 110) to record therein evacuation data which is record data to be recorded at a position of a defect in the data area or which is record data recorded at the position; and a temporary defect management area (104, 105) to temporarily record therein defect management information including (120) at least an evacuation source address which is an address of the position and an evacuation destination address which is an address of a recording position of the evacuation data, the evacuation destination address being specified by a first offset address based on one predetermined point in the spare area.

### TECHNICAL FIELD

The present invention relates to an information recording medium, an apparatus for and a method of recording record data onto the information recording medium, an apparatus for and a method of reproducing the record data recorded on the information recording medium, a computer program for recording or reproduction control, and a data structure including a control signal for recording or reproduction control.

### BACKGROUND ART

As a technique of improving the reliability of the recording and reading of record data on a high-density recording medium, such as an optical disc, a magnetic disc, and a magneto optical disc, there is defect management. Namely, if there are scratches, dusts or deterioration (which are collectively referred to as a “defect”) on the recording medium, data to be recorded or already recorded at the position of the defect is recorded into another area on the recording medium (which is referred to as a “spare area”). As described above, by evacuating, to the spare area, the record data which is possibly imperfectly or incompletely recorded or read because of the defect, it is possible to improve the reliability of the recording and reading of the record data (refer to Japanese Patent Application Laying Open NO. Hei 11-185390).

In general, a defect list is generated to perform the defect management. On the defect list, there are recorded address information for indicating the position of a defect on the recording medium, and address information for indicating a position in the spare area (e.g. a recording position in the spare area) to which the data to be recorded or already recorded at the position of the defect is evacuated.

In general, the defect list is generated upon the initialization of the recording medium or initial logical formatting for recording file system data. The defect list is also generated when the record data is recorded onto the recording medium. If the record data is recorded and rewritten several times, the defect list is generated or updated every time the record data is recorded and rewritten, and every time a defect area is detected.

When the record data is recorded onto the recording medium, the defect list is referred to. This allows the recording of the record data onto the recording medium away from the position of a defect. On the other hand, the defect list is also referred to when the record data recorded on the recording medium is reproduced. This makes it possible to surely read both the record data recorded in a normal recording area and the record data recorded in the spare area because of the presence of a defect, on the basis of the defect list.

The defect list is generally recorded into a specific area on the recording medium, which is a generation or update target of the defect list, if a data recording apparatus itself manages the defect list. The defect list is read from the recording medium when the record data recorded on the recording medium is reproduced next time or when other record data is rewritten or additionally recorded next time. Then the defect list is referred to in a recording operation by a recording apparatus or in a reproduction operation by a reproducing apparatus.

### DISCLOSURE OF INVENTION

By the way, if the recording apparatus manages the defect list, the defect list is recorded into a specific area on the recording medium. For example, with respect to a rewritable optical disc using a blue laser, the defect list is recorded into a predetermined area (which is hereinafter referred to as a “defect management area”) reserved in a lead-in area or lead-out area on the disc. Then, the record data to be originally recorded at the position where the defect is present is also recorded into a specific area on the recording medium.

As described above, the defect list is updated every time the record data is recorded and rewritten, and every time the defect area is detected. Then, the defect list is overwritten or additionally recorded into the defect management area on the recording medium, which is the recording and rewriting target for the defect list, in proper timing, after the defect list is updated by the recording and rewriting of record data. In addition, the record data to be originally recorded at the position where the defect is present is also overwritten or additionally recorded into a specific area on the recording medium.

Such updating of the defect list by rewriting it can be realized only in a case where the recording medium is a rewritable-type. If the recording medium is a so-called write-once-type information recording medium, for example, a write-once-type optical disc, the updated defect list is additionally recorded into a new unrecorded area on the information recording medium after the defect list is updated, in proper timing.

On the other hand, in the optical disc using the blue laser, it is possible to realize a large recording capacity due to the reduction of the wavelength of the laser. For example, if the optical disc is provided with one recording layer, it has a recording capacity of about 25 GB, and if provided with two recording layers, the recording capacity thereof reaches about 50 GB. In association with this, the address information for specifying a position on the recording medium has a larger data size. For example, in the optical disc with the two recording layers, the address information thereof is expressed by a physical address, and it needs an information amount of less than about 4 bytes in order to express the value of a physical address having a maximum value. Then, the optical disc holds a plurality of address information having such a large address value. At the same time, for example, on the write-once-type recording medium, new address information is additionally recorded.

Thus, a recording capacity required for the recording of the address information becomes enormous, and as a result, there is such a technical problem that it is impossible to fully perform the defect management or that the recording capacity for the record data including content to be originally recorded becomes small.

In addition, as the address information increases, there is more possibility of cluster overflow. In other words, since the address information is large, the defect list which holds an evacuation source address and an evacuation destination address of the data will have a larger size, which causes less number of the address information which can be recorded into one cluster. Therefore, in the case of the same additional recording number (or the same write-once recording number), as the address information is larger, the data overflows from the cluster more quickly. If one cluster cannot contain the defect management information any more, i.e. if it overflows, another cluster is used to record the defect management information. Since the recording of the data by a unit other than a cluster unit is not allowed as the standard, a cluster-size area is always consumed by the additional recording even if the address information of a smaller size than the cluster size is recorded. Incidentally, a remaining unrecorded area in the cluster is padded by zero data or the like. Therefore, there is such a technical problem that the use efficiency of the disc deteriorates more, which reduces an available area on the entire recording medium, as this type of overflow occurs more often.

Moreover, on the border of one cluster and another cluster, if a remaining space area of the one cluster does not have a data capacity large enough to record the address information therein, the recording is performed not in the space area but in another cluster. This can be said that it is a technical problem caused by the standard that the recording of the data over the two clusters is not allowed. Thus, there is also such a technical problem that an increase in such a spare space may reduce an available area as the entire recording medium.

It is therefore an object of the present invention to provide: an information recording medium which allows the efficient use of the recording capacity of the recording medium; an apparatus for and a method of recording the record data onto the information recording medium; an apparatus for and a method of reproducing the record data recorded on the information recording medium, a computer program used on the recording or reproducing apparatus, and a data structure including a control signal for recording or reproduction control.

The present invention will be discussed below.

(Information Recording Medium)

The above object of the present invention can be achieved by an information recording medium provided with: a data area to record therein record data; a spare area to record therein evacuation data which is record data to be recorded at a position of a defect in the data area or which is record data recorded at the position; and a temporary defect management area to temporarily record therein defect management information including at least an evacuation source address which is an address of the position and an evacuation destination address which is an address of a recording position of the evacuation data, the evacuation destination address being specified by a first offset address based on one predetermined point in the spare area.

According to the information recording medium of the present invention, it is possible to record the record data, which is the data targeted for the reproduction or execution and which includes a series of contents, such as image data, audio data, text data, content data and a computer program, into the data area. Then, it is possible to properly record and reproduce the record data recorded in the data area, by recording information which indicates the attribute and type of the information recording medium of the present invention, information for the address management of the record data and information for controlling the recording operation and the reading operation of a drive apparatus, into a control information recording area described later. Incidentally, the record data and control information cannot be always clearly distinguished, in accordance with the content thereof. However, the control information is mainly information directly used for the operation control of the drive apparatus, while the record data is mainly data which is merely a recording and reading target and is mainly used in the data reproduction process or program execution process of a backend or host computer.

Into the temporary defect management area, the defect management information of the data area is temporary recorded. The “defect management information” in the present invention is information used for the defect management, and includes the evacuation source address which is the address of the position of a defect in the data area and the evacuation destination address which is an address of the recording position of the evacuation data which is the record data to be originally recorded or already recorded at the position of the defect. The defect management is as follows. If there is a defect, such as scratches, dusts and deterioration, in or on the information recording medium of the present invention, the record data is recorded away from the position of the defect. At the same time, the evacuation data is recorded into the spare area. Moreover, the following processes i.e., process of recognizing the position of a defect upon reproducing the record data recorded on the information recording medium and process of reading the evacuation data from the spare area are also performed as a part of the defect management.

Then, for example, the temporary defect management area is an area to record therein the defect management information until the information recording medium of the present invention is finalized, for example. Therefore, for example, until the information recording medium is finalized, if the information on the information recording medium is reproduced, the defect management is performed by reading the defect management information from the temporary defect management area. Incidentally, the information recording medium may be provided thereon with one temporary defect management area, or two, three or more temporary defect management areas.

Particularly in the present invention, the evacuation destination address included in the defect management information is specified by the first offset address. For example, the first offset address is based on the predetermined one point in the spare area as a reference point, and the evacuation destination address is specified by an offset value from the reference point (i.e. the offset address).

The one point may be the start point of the spare area, as described later, may be a point corresponding to the central portion of the spare area, or may be a point corresponding to the end portion thereof. Alternatively, it may be another point selected arbitrarily. Furthermore, it may be defined in advance at the time of the manufacture of the information recording medium, or may be set when a user records the record data for the first time onto the information recording medium.

As described above, if the offset address is used, there is the following advantage, as compared to the case where the evacuation destination address is specified by using the physical address (i.e. a peculiar address allocated by a sector unit on the entire information recording medium, etc.).

If the physical address is used to specify the evacuation destination address, more data amount is required in most cases to show the evacuation destination address near the central portion and the end portion of the recording area of the information recording medium because the physical address has a large value near the central portion and the end portion of the recording area of the information recording medium, for example.

However, as in the present invention, if the first offset address based on the one point is used, it is possible to reduce the data amount of the offset address by allocating the one point as a predetermined point near the central portion or the like. In other words, by converting the physical address having a large value to a relative address value based on the one point, the evacuation address can be relatively small value as compared to the physical address. More specifically, it is assumed that there is a spare area expressed by physical addresses “100000” to “1500000”. In this case, in order to specify the position of the spare area by using the physical address, a data amount of 3 bytes is required. However, as in the present invention, if the start point of the spare area (i.e. the point expressed by the physical address of “100000”) is regarded as the one point, for example, it is possible to express the first offset address of the spare area by “0” to “50000”. Therefore, it is possible to specify the position of the spare area by the address value having a data amount of 2 bytes, by using the first offset address. As a result, it is possible to reduce the data amount of the entire defect management information.

Comparing the case where the physical address is used with the case where the offset address is used, a larger-capacity information recording medium has a greater effect of the reduction of the data amount.

In addition, as in the write-once-type information recording medium, if the defect management information is additionally recorded or written once every time a new defect occurs without deleting or eliminating old defect management information, the data amount of the defect management information will be likely too enormous to underestimate, as compare to the data amount of the entire information recording medium. However, according to the information recording medium of the present invention, it is possible to reduce the data amount of the defect management information. Therefore, it is possible to perform the defect management, properly, without greatly influencing the recording capacity of the entire information recording medium.

It is also possible to reduce the occurrence frequency of cluster overflow by reducing the data amount of the evacuation destination address. In other words, it is possible to record the evacuation destination address having a smaller address value into a space area in which the evacuation destination address having a large address value cannot be recorded. Thus, it is possible to reduce the occurrence of the space area, to thereby increase an available area in the entire information recording medium (i.e. an available area as a user data area).

Consequently, according to the information recording medium of the present invention, it is possible to reduce the data amount of the defect management information and efficiently use the information recording medium, by reducing the data amount of the evacuation destination address and the evacuation source address. In particular, the reduction of the data amount of the defect management information is remarkably shown in the information recording medium having a large recording capacity. Along with that, an area which can be allocated for the user data area increases, and the recording capacity of the record data as the entire information recording medium can be increased.

Incidentally, not only in the case of the large-capacity information recording medium but also in the case of the information recording medium on which the address information is used to perform the defect management, it is possible to receive various benefits of the information recording medium of the present invention.

In one aspect of the information recording medium of the present invention, it is further provided with a control information recording area to record therein information for controlling at least one of operations of recording and reading in the data area, the control information recording area including a definite defect management area to record therein defect management information of the data area.

According to this aspect, it is possible to maintain compatibility between the information recording medium of the present invention and a rewritable type information recording medium, for example.

For example, the definite defect management area is an area to record therein the defect management information when the information recording medium is finalized, and thus the defect management information is not updated anymore, and the content of the defect management information is determined. Therefore, if the information recording medium is finalized before the reproduction, the defect management is performed by reading the defect management information from the definite defect management area.

In addition, the definite defect management area is disposed in the control information recording area. In many information recording media of a rewritable type, which is generally popular and in which a recording apparatus manages a defect list, the defect management area is disposed in the control information recording area. Moreover, even in many information recording media of a rewritable type which will be developed, it is expected that the defect management area is disposed in the control information recording area. Therefore, in the present invention, it is possible to provide compatibility with the rewritable type information recording medium of the same standard because it adopts the same structure of such a general rewritable type recording medium. As a result, it is possible to properly reproduce the information recording medium of the present invention on various reproducing apparatuses of a reproduce-only type and of a rewritable type. Therefore, there is an extremely large advantage in the point of easy diffusion to the public.

Incidentally, the definite defect management area may be smaller than the temporary defect management area. This is because it is only necessary to record at least one defect management information whose content is determined.

On the other hand, the temporary defect management area is preferably larger than the definite defect management area. This is because it is necessary to record a plurality of defect management information in accordance with the number of updated times, if the defect management information is updated several times. It is considered that the updated defect management information cannot be overwritten at the same position because the information recording medium of the present invention is a write-once-type information recording medium in which the recording is performed only once.

Moreover, the definite defect management area may be provided not only in the control information recording area disposed on the inner circumferential side of the information recording medium of the present invention but also in the control information recording area disposed on the outer circumferential side of the information recording medium, as in the above-mentioned temporary defect management area. Furthermore, in the case of a two-layer disc, one or more definite defect management areas may be provided in each layer.

In an aspect of the information recording medium provided with the control information recording area, as described above, the temporary defect management area is disposed between the control information recording area and the data area.

According to this aspect, it is possible to reserve or ensure the temporary defect management area without expanding the control information recording area, by disposing the temporary defect management area out of the control information recording area. As described later, the temporary defect management area is relatively large, so if it is disposed in the control information recording area, it will be forced to expand the control information recording area. However, by disposing the temporary defect management area between the control information recording area and the data area, it is possible to provide the temporary defect management area on the information recording medium of the present invention, without expanding the control information recording area and without disposing the temporary defect management area in the data area. Thus, there is an extremely great advantage that it is possible to provide the compatibility between the information recording medium of the present invention and the general rewritable type information recording medium.

In another aspect of the information recording medium of the present invention, the one point corresponds to a start point of the spare area.

According to this aspect, it is possible to specify the evacuation destination address, relatively easily, from the relative position of the evacuation data in the spare area, by setting the start point to one point. The “start point” of the present invention is a point located on the most inner circumferential side of tracks which constitute the spare area, and in terms of the physical address, it is a point having the smallest physical address value in the spare area. In addition, for example, in the recording and reproduction operations of a recording/reproducing apparatus described later, it is possible to reduce a processing load related to the address operation or calculation.

In another aspect of the information recording medium of the present invention, a point defining information to define the one point is recorded.

According to this aspect, it is possible to specify the first offset address from the physical address, relatively easily, upon recording the record data, for example, by using the point defining information. Here, the point defining information of the present invention conceptually means information which indicates the one point, by using the physical address or a relative address based on another referent point (or an offset address), for example. Alternatively, upon reproducing the record data, it is possible to specify the actual physical address from the first offset address, relatively easily. Therefore, it is possible to improve a process performance related to the recording or reproduction operation (e.g. speed-up).

Incidentally, in the case of the information recording medium having the control information recording area, the point defining information may be recorded into the control information recording area, or may be recorded into another area (e.g. the temporary defect management area, the user data area, the spare area, etc.) as header information of the defect management area, for example.

In another aspect of the information recording medium of the present invention, the evacuation source address is specified by a second offset address based on another predetermined point in the data area.

According to this aspect, it is possible to further reduce the data amount of the defect management information by specifying the evacuation source address with the second offset address expressed by the offset value, as in the evacuation destination address.

Incidentally, as in the above-mentioned “one point”, another point may correspond to the start point of the data area, or may correspond to another arbitrary point in the data area. Moreover, in an aspect in which the point defining information is included, information for defining another point may be included in the point defining information.

In another aspect of the information recording medium of the present invention, the information recording medium is provided with a plurality of spare areas, and the first offset address is an address which is bridged over the plurality of spare areas based on the one point defined by only one with respect to the plurality of spare areas.

According to this aspect, even in the case of the write-once-type information recording medium having the plurality of spare areas, it is possible to specify the evacuation destination address, properly.

Specifically, if the information recording medium is provided with two spare areas, the first offset address is specified by setting the start point of one of the two spare areas to the one point. By this, even in the case of the information recording medium having the plurality of spare areas, it is possible to specify the evacuation destination address, properly, by using the first offset address.

Incidentally, the physical addresses of the plurality of spare areas may be continuous or discontinuous. If discontinuous, the plurality of spare areas may be regarded as a single spare area obtained by combining the spare areas, and the first offset address may be specified on the basis of the one point.

Even the second offset address may be constructed in the same manner as the first offset address. For example, if there are a plurality of data areas, the second offset address may be an address which is bridged over the plurality of data areas based on another point which is defined by only one with respect to the plurality of data areas. Then, the plurality of data areas may be continuous or discontinuous on the physical address.

(Recording Apparatus and Method)

The above object of the present invention can be also achieved by a recording apparatus for recording record data onto an information recording medium provided with: (i) a data area to record therein record data; (ii) a spare area to record therein evacuation data which is record data to be recorded at a position of a defect in the data area or which is record data recorded at the position; and (iii) a temporary defect management area to temporarily record therein defect management information including at least an evacuation source address which is an address of the position and an evacuation destination address which is an address of a recording position of the evacuation data, the recording apparatus provided with: a defect management information generating device for generating or updating the defect management information; and a recording device for recording at least one of the record data, the evacuation data, and the generated or updated defect management information, the defect management information generating device generating the evacuation destination address which is specified by a first offset address based on one predetermined point in the spare area, to thereby generate or update the defect management information.

According to the recording apparatus of the present invention, it is possible to properly record the record data onto the above-mentioned information recording medium of the present invention, by using the recording device which includes an optical pickup and a controller for controlling the optical pickup, and the like, for example.

Specifically, the recording device records the record data into the data area of the information recording medium. On the other hand, on the recording apparatus of the present invention, the defect management information including the defect list, for example, which indicates the position or the like of a defect on the information recording medium, is generated by the defect management information generating device. The generated or obtained defect management information may be stored into a storing device which includes a memory, such as a RAM, for example.

At this time, in the present invention, the defect management information is generated so as to specify the evacuation destination address by using the first offset address. Specifically, in generating the evacuation destination address which indicates the position of the defect, the defect management information generating device generates the first offset address which is based on the predetermined one point in the spare area and which can specify the evacuation destination address. Then, it generates the defect management information including the first offset address as the evacuation destination address.

Then, the recording device records the defect management information generated in this manner into the temporary defect management area of the information recording medium. Recording the defect management information into the temporary defect management area may be performed in various timing. The timing may be immediately after the information recording medium is initialized or formatted, after a series of the record data is recorded onto the information recording medium, immediately after a defect is detected after writing verification (after verifying) and the like. In addition, the recording device records the evacuation data into the spare area.

Consequently, according to the recording apparatus of the present invention, it is possible to properly record the record data onto the above-mentioned information recording medium of the present invention, and receive the various benefits owned by the information recording medium.

Incidentally, the recording apparatus of the present invention may also adopt various aspects, in response to various aspects of the information recording medium of the present invention mentioned above.

Moreover, the defect management information may be obtained through the information recording medium or another communication channel. In this case, the defect management information generating device is preferably constructed to obtain the defect management information through the information recording medium or another communication channel, instead of generating or updating the defect management information.

If the information recording medium is an optical type recording medium, an optical pickup is preferable as a device for directly recording the data or information onto the information recording medium. If the information recording medium is of another type, such as a magnetic type, a magneto optical type and a type using the change of a dielectric constant, a pickup, head, probe, or the like which suits the type of the information recording medium may be used.

Moreover, the recording device may record the defect management information, repeatedly a plurality of times, into the temporary defect management area (or the definite defect management area). By this, it is possible to surely hold the defect management information on the information recording medium.

In addition, an area setting device may be further provided to set the size of the temporary defect management area and the position of the data area in accordance with the size of the temporary defect management area which is set. For example, if the temporary defect management area is set to be large, it is possible to record more defect management information into the temporary defect management area. In other words, in this case, the defect management information can be recorded many times, so that it is possible to record each defect management information, even if the number of updating reaches many. By this, even if the information recording medium is used in a bad environment where a defect occurs frequently, it is possible to maintain or increase the reliability of the recording and reproduction of the record data. Moreover, it is possible to increase the number of the defect management information with the same content to be repeatedly recorded, to thereby increase certainty about the recording and retention of the defect management information. On the other hand, if the temporary defect management area is set to be small, the data area can be ensured to be large, so that it is possible to increase the practical recording capacity of the information recording medium. If the setting range of the temporary defect management area performed by the area setting device is entrusted to a user, it is possible to properly set the temporary defect management area, in accordance with the aspect of how the user uses the information recording medium.

Then, since the data amount of the defect management information can be reduced by using the offset address, it is possible to efficiently use the recording capacity of the information recording medium if the defect management information is recorded a plurality of times and the temporary defect management area is set to be large. In other words, the advantage owned by the recording apparatus of the present invention, which is a possibility of reducing the data amount of the defect management information, is prominently expressed in such a case, and it is possible to increase the certainty about the recording and retention while efficiently using the recording capacity.

In one aspect of the recording apparatus of the present invention, the defect management information generating device generates or updates the defect management information with a start point of the spare area as the one point.

According to this aspect, it is possible to generate the evacuation destination address by using the first offset address, relatively easily, by setting the start point of the spare area whose position can be relatively easily specified on the recording apparatus, to the one point. Therefore, it is possible to improve the process performance related to the recording operation (e.g. speed-up or the like of the recording operation, reduction of power consumption by simplifying the operation, etc.).

In another aspect of the recording apparatus of the present invention, the information recording medium is further provided with a control information recording area to record therein point defining information for defining the one point, and the defect management information generating device generates or updates the defect management information on the basis of the point defining information.

According to this aspect, it is possible to specify the first offset address, relatively easily, from the physical address, for example, by generating the defect management information on the basis of the point defining information. Therefore, it is possible to improve the process performance related to the recording operation.

In another aspect of the recording apparatus of the present invention, it is further provided with: a first recording control device for controlling the recording device to record the defect management information into the temporary defect management area if the defect management information generating device generates or updates the defect management information.

According to this aspect, it is possible to reflect a defect which exists in the data area upon recording, in the defect management information.

More specifically, for example, when the recording process of the record data into the data area is performed, the record data is recorded in each predetermined block, and verification is performed at each time of the recording in one block. The “verification” indicates an error detection operation of checking whether or not there is an error in the recorded data, or the like. The defect management information generating device preferably uses the result of the verification, for example, to thereby generate or update the defect management information. The defect management information may be stored into a storing device, for example. As described above, it is possible to generate or update the defect management information upon recording the record data, and reflect a defect which exists in the data area upon the recording, in the defect management information.

When the defect management information generating device generates or updates the defect management information, the first recording control device controls the recording device to record the defect management information into the temporary defect management area. The timing that the first recording control device controls the recording device to record the defect management information into the temporary defect management area may be in the middle of the generation of the defect management information by the defect management information generating device, or immediately after the generation of the defect management information is completed, or furthermore, a short time after the generation of the defect management information is completed.

By this, it is possible to reflect a defect which exists in the data area upon recording, in the defect management information, to thereby record the defect management information into the defect management area and hold it.

In another aspect of the recording apparatus of the present invention, the recording apparatus is further provided with a defect management information obtaining device for reading the defect management information from the temporary defect management area of the information recording medium on which the defect management information is recorded in the temporary defect management area, the defect management information generating device updates the defect management information read by the defect management information obtaining device when the recording device records the record data into the data area, and the first recording control device controls the recording device to record the defect management information into the temporary defect management area when the defect management information is updated.

According to this aspect, it is possible to reflect a new defect formed on the data area, in the defect management information already recorded in the temporary defect management area.

More specifically, if the defect management information is already recorded in the temporary defect management area of the information recording medium loaded on the recording apparatus of the present invention, for example, the defect management information obtaining device reads the defect management information from the temporary defect management area. Then, the defect management information may be stored into a storing device, such as a memory, for example. Then, the defect management information generating device updates the defect management information which is read by the defect management information obtaining device when the recording device records the record data into the data area. Then, the first recording control device controls the recording device to record the defect management information into the temporary defect management area when the defect management information is updated.

By this, it is possible to update the defect management information on the basis of the defect management information which was recorded in the temporary defect management area in the past, record the updated defect management information into the temporary defect management area. By this, it is possible to reflect a new defect formed on the data area, in the defect management information, and hold this information in the temporary defect management area of the information recording medium.

Incidentally, when the information recording medium of the present invention is initialized or formatted, the defect management information generating device may generate the defect management information for the information recording medium on which the record data is unrecorded. In this case, the first recording control device is preferably constructed to control the recording device to record the defect management information into the temporary defect management area when the defect management information generating device generates the defect management information.

By this, it is possible to record the defect management information generated upon the initialization of the information recording medium or initial logical formatting or the like, in the temporary defect management area. Incidentally, the “initialization or initial logical formatting” means an initial operation performed for the information recording medium (e.g. initial error check, determination of a disc structure, such as the size of the spare area on the disc and the size of the temporary defect management area).

In addition, the above-mentioned defect management information generating device may be provided with; a defect detecting device for detecting a defect in the data area; and a spare area ensuring device for ensuring or reserving a spare area corresponding to the defect in the data area.

In another aspect of the recording apparatus of the present invention, the information recording medium is further provided with a control information recording area to record therein information for controlling at least one of operations of recording and reading in the data area, the control information recording area including a definite defect management area to record therein defect management information of the data area, and the recording apparatus is further provided with: a finalize command device for giving a command to finalize the information recording medium; and a second recording control device for controlling the recording device to record the generated or updated defect management information into the definite defect management area when finalize command device gives a command to finalize the information recording medium.

According to this aspect, it is possible to provide the compatibility between the information recording medium of the present invention and the rewritable type information recording medium, by recording the defect management information into the definite defect management area upon the finalizing. Here, the “finalizing” conceptually includes operations in general, in which the address information, control information or the like of the data recorded on the information recording medium are sorted out and the information recording medium with general versatility may be made. For example, by finalizing the information recording medium, it is possible to reproduce the information which is recorded on the write-once-type information recording medium, on a reproduce-only reproducing apparatus or various reproducing apparatuses corresponding to another information recording medium.

More specifically, when a user wants to reproduce the record data recorded on the information recording medium with a reproducing apparatus for the rewritable-type information recording medium or a reproduce-only reproducing apparatus, the user inputs an instruction to perform the finalizing, to the recording apparatus of the present invention. In accordance with this, the finalize command device gives a command to finalize the information recording medium currently loaded on the recording apparatus. Moreover, if the data area is filled with the record data and the recording device judges it is not preferable to further record the record data, the recording apparatus may automatically perform the finalizing. If such construction is adopted, the finalize command device gives a command to finalize the information recording medium, in accordance with the judgment of the recording apparatus.

Then, the second recording control device controls the recording device to record the defect management information stored in a storing device, for example, into the definite defect management area when the finalize command device gives a command to perform the finalizing. Then, the recording device records the defect management information recorded in the storing device, into the definite defect management area of the information recording medium. As a result, the defect management information is recorded in the definite defect management area of the information recording medium after the information recording medium is finalized.

By this, it is possible to provide the compatibility between the information recording medium of the present invention and the rewritable-type information recording medium. In most cases, the finalizing is performed when the user thinks the recording of the record data is completed. Thus, it is possible to establish the compatibility between the information recording medium of the present invention and the rewritable-type information recording medium, in timing which matches the user's will, by using a chance of the finalizing to record the defect management information into the definite defect management area.

Incidentally, the finalize command device may give a command to perform the finalizing in accordance with an eject command. This also makes it possible to establish the compatibility between the information recording medium of the present invention and the rewritable-type information recording medium, in timing which matches the user's will.

Moreover, the recording device may record the defect management information into the definite defect management area, repeatedly, a plurality of times. In addition, the recording device may record the defect management information into a plurality of definite defect management areas which exist at a plurality of positions on the information recording medium, redundantly.

The above object of the present invention can be also achieved by a recording method in a recording apparatus for recording record data onto an information recording medium provided with: (i) a data area to record therein record data; (ii) a spare area to record therein evacuation data which is record data to be recorded at a position of a defect in the data area or which is record data recorded at the position; and (iii) a temporary defect management area to temporarily record therein defect management information including at least an evacuation source address which is an address of the position and an evacuation destination address which is an address of a recording position of the evacuation data, the recording method provided with: a defect management information generating process of generating or updating the defect management information; and a recording process of recording at least one of the record data, the evacuation data, and the generated or updated defect management information, the defect management information generating process generating the evacuation destination address which is specified by a first offset address based on one predetermined point in the spare area, to thereby generate or update the defect management information.

According to the recording method of the present invention, as in the above-mentioned recording apparatus of the present invention, it is possible to properly record the record data onto the information recording medium of the present invention (including its various aspects).

Incidentally, the recording method of the present invention may also adopt various aspects, in response to various aspects of the recording apparatus (or information recording medium) of the present invention mentioned above.

(Reproducing Apparatus and Method)

The above object of the present invention can be also achieved by a reproducing apparatus for reproducing the record data recorded on the above-mentioned information recording medium of the present invention (including its various aspects), the reproducing apparatus provided with: a storing device; a first reading device for reading the defect management information recorded in the temporary defect management area and storing the read defect management information into the storing device; and a reproducing device for reproducing the record data recorded in the data area or the evacuation data recorded in the spare area, on the basis of the defect management information stored in the storing device, the reproducing device calculating the evacuation destination address on the basis of the first offset address.

According to the reproducing apparatus of the present invention, it is possible to properly reproduce the record data recorded on the above-mentioned information recording medium of the present invention, by using the first reading device, which includes an optical pickup, a controller for recording the optical pickup, and the like, and the reproducing device, which includes a decoder for converting the image data to an image signal which allows the display of the image data on a display, and the like.

Specifically, at first, the first reading device reads the defect management information recorded in the temporary defect management area. Then, the defect management information is stored into the storing device, such as a memory, for example. Upon recording, the record data is recorded away from a defect which exists in the data area of the information recording medium. In other words, the defect portion which exists in the data area is evacuated to the spare area. Thus, in order to reproduce the record data recorded in this manner, it is necessary to know the position of the defect in the data area upon the recording. Thus, the reproducing device learns the position of the defect in the data area, on the basis of the defect management information stored in the storing device, and recognizes the recording position of the record data recorded away from the defect, to thereby reproduce the record data recorded in the data area or the evacuation data recorded in the spare area.

Particularly in the present invention, the reproducing device can specify the position where the evacuation data is properly recorded, by using the first offset address. For example, it is possible to obtain the physical address by performing a predetermined process or operation or calculation or the like to the offset address, to thereby properly access the evacuation data.

Consequently, according to the reproducing apparatus of the present invention, it is possible to properly reproduce the information recorded on the above-mentioned information recording medium of the present invention.

Incidentally, the reproducing apparatus of the present invention may also adopt various aspects, in response to various aspects of the information recording medium of the present invention mentioned above.

The above object of the present invention can be also achieved by a reproducing method in a reproducing apparatus for reproducing the record data recorded on above-mentioned the information recording medium of the present invention (including its various aspects), the reproducing method provided with: a first reading process of reading the defect management information recorded in the temporary defect management area; and a reproducing process of reproducing the record data recorded in the data area or the evacuation data recorded in the spare area, on the basis of the read defect management information, the reproducing process calculating the evacuation destination address on the basis of the first offset address.

According to the reproducing method of the present invention, as in the reproducing apparatus of the present invention, it is possible to properly reproduce the record data recorded on the above-mentioned information recording medium of the present invention (including its various aspects).

Incidentally, the reproducing method of the present invention may also adopt various aspects, in response to various aspects of the reproducing apparatus of the present invention mentioned above.

(Computer Program)

The above object of the present invention can be also achieved by a computer program for recording control to control a computer disposed in the above-mentioned recording apparatus of the present invention (including its various aspects), the program making the computer function as at least one portion of the defect management information generating device and the recording device.

According to the computer program for recording control of the present invention, the recording apparatus of the present invention mentioned above may be realized relatively easily, by running the computer program from a recording medium, such as a ROM, a CD-ROM, a DVD-ROM, a hard disk and so on, which stores the computer program thereon, as the firmware of the recording apparatus, or by downloading the computer program to the computer via the communication device and running it.

Incidentally, the computer program for recording control of the present invention may also adopt various aspects, in association with various aspects of the information recording medium of the present invention mentioned above.

The above object of the present invention can be also achieved by a computer program for reproduction control to control a computer disposed in the above-mentioned reproducing apparatus of the present invention (including its various aspects), the program making the computer function as at least one portion of the first reading device and the reproducing device.

According to the computer program for reproduction control of the present invention, the reproducing apparatus of the present invention mentioned above may be realized relatively easily, by running the computer program from a recording medium, such as a ROM, a CD-ROM, a DVD-ROM, a hard disk and so on, which stores the computer program thereon, or by downloading the computer program to the computer via the communication device and running it.

Incidentally, the computer program for reproduction control of the present invention may also adopt various aspects, in association with various aspects of the information recording medium of the present invention mentioned above.

The above object of the present invention can be also achieved by a computer program product for recording control in a computer-readable medium for tangibly embodying a program of instructions executable by a computer provided for the above-mentioned recording apparatus of the present invention (including its various aspects), the program making the computer function as at least one portion of the defect management information generating device and the recording device.

The above object of the present invention can be also achieved by a computer program product for reproduction control in a computer-readable medium for tangibly embodying a program of instructions executable by a computer provided for the above-mentioned reproducing apparatus of the present invention (including its various aspects), the program making the computer function as at least one portion of the first reading device and the reproducing device.

According to the computer program product for the recording or reproduction control of the invention, at least one portion of the defect management information generating device, the recording device, the first reading device and the reproducing device of the present invention mentioned above may be embodied relatively easily, by reading and running the computer program product from a record medium, such as a ROM, a CD-ROM, a DVD-ROM, a hard disk and so on, which stores the computer program thereon, or by downloading the computer program product to the computer via the communication device and running it. More specifically, the computer program product may be made of computer readable codes (or computer readable commands) to make the computer function as at least one portion of the defect management information generating device, the recording device, the first reading device and the reproducing device.

(Data Structure Including Control Signal)

The above object of the present invention can be also achieved by a data structure provided with: a data area to record therein record data; a spare area to record therein evacuation data which is record data to be recorded at a position of a defect in the data area or which is record data recorded at the position; and a temporary defect management area to temporarily record therein defect management information including at least an evacuation source address which is an address of the position and an evacuation destination address which is an address of a recording position of the evacuation data, the evacuation destination address being specified by a first offset address based on one predetermined point in the spare area.

According to the data structure including the control signal of the present invention, similarly to the case of the information recording medium of the present invention as mentioned above, it is possible to reduce the data amount of the defect management information by specifying the evacuation destination address from the offset address, to thereby efficiently use the information recording medium.

Incidentally, the data structure including the control signal of the present invention may also adopt various aspects, in association with various aspects of the information recording medium of the present invention mentioned above.

These effects and other advantages of the present invention become more apparent from the following embodiments and examples.

As explained above, according to the information recording medium of the present invention, it is provided with: the data area; the spare area; and the temporary defect management area, the evacuation destination address being specified by the first offset address based on one point in the spare area. Therefore, it is possible to reduce the data amount of the defect management information and efficiently use the information recording medium.

Moreover, according to the recording apparatus or method of the present invention, it is provided with the defect management information generating device and the recording device, or the defect management information generating process and the recording process, respectively. Thus, it is possible to properly record the record data onto the information recording medium of the present invention. Moreover, according to the reproducing apparatus or method of the present invention, it is provided with the first reading device and the reproducing device, or the first reading process and the reproducing process, respectively. Thus, it is possible to properly read and reproduce the record data from the information recording medium of the present invention.

### BRIEF DESCRIPTION OF DRAWINGS

FIG. 1 is an explanatory diagram showing an embodiment of an information recording medium of the present invention.

FIG. 2 is an explanatory diagram showing the content of defect management information in the embodiment.

FIG. 3 is an explanatory diagram showing one example of a defect list in the embodiment.

FIG. 4 is an explanatory diagram showing one example of the recoding content of a temporary defect management area in the embodiment.

FIG. 5 is an explanatory diagram showing one example of the recoding content of a definite defect management area in the embodiment.

FIG. 6 is an explanatory diagram schematically showing a relationship between the data structure of a data zone in the embodiment and the address thereof.

FIG. 7 are explanatory diagrams, each showing a specific example of the defect list in the embodiment or the defect list in a comparison example.

FIG. 8 is a block diagram showing a recording/reproducing apparatus, which is an embodiment of a recording apparatus and a reproducing apparatus of the present invention.

FIG. 9 is a block diagram showing a disc drive of the recording/reproducing apparatus in the embodiment.

FIG. 10 is a block diagram showing a backend of the recording/reproducing apparatus in the embodiment.

FIG. 11 is a flowchart showing the initial setting operation of the recording/reproducing apparatus in the embodiment.

FIG. 12 is a flowchart showing the recording operation and the like of the recording/reproducing apparatus in the embodiment.

FIG. 13 is a flowchart particularly showing an address operation (or calculation) operation in the recording operation of the recording/reproducing apparatus in the embodiment.

FIG. 14 is a flowchart showing the finalize process of the recording/reproducing apparatus in the embodiment.

FIG. 15 is a flowchart showing the reproduction operation of the recording/reproducing apparatus in the embodiment.

FIG. 16 is an explanatory diagram showing another embodiment of the information recording medium of the present invention.

### BEST MODE FOR CARRYING OUT THE INVENTION

The embodiments of the present invention will be explained with reference to the drawings hereinafter. In the embodiments below, the information recording medium of the present invention is applied to a write-once-type optical disc, and the recording apparatus and the reproducing apparatus of the present invention are applied to a recording/reproducing apparatus for the write-once-type optical disc.

### Embodiment of Information Recording Medium

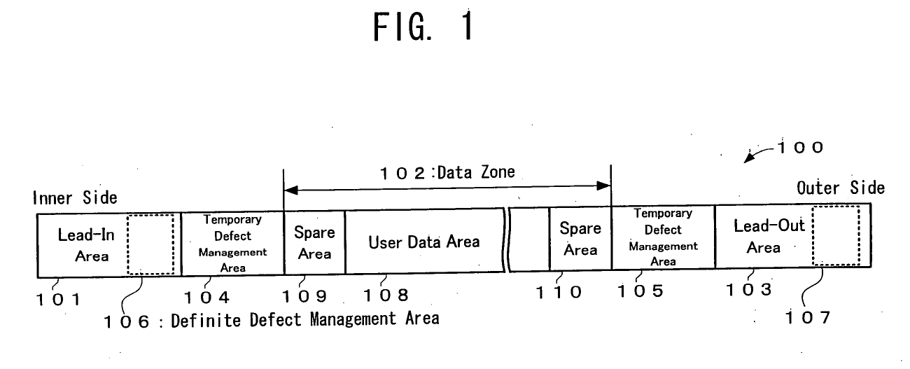

The recording structure of the write-once-type optical disc in the embodiment of the present invention, and information and data recorded on the optical disc will be discussed. FIG. 1 shows the recording structure of the write-once-type recording medium in the embodiment of the present invention. Incidentally, the left side of FIG. 1 is the inner circumferential side of a write-once-type optical disc 100, and the right side is the outer circumferential side of the write-once-type optical disc 100.

As shown in FIG. 1, on the recording surface of the write-once-type optical disc 100, there are: a lead-in area 101 on the inner circumferential side; a data zone 102 on the outer circumferential side of the lead-in area 101; and a lead-out area 103 on the outer circumferential side of the data zone 102. Moreover, a temporary defect management area 104 is located between the lead-in area 101 and the data zone 102. Furthermore, a temporary defect management area 105 is located between the data zone 102 and the lead-out area 103.

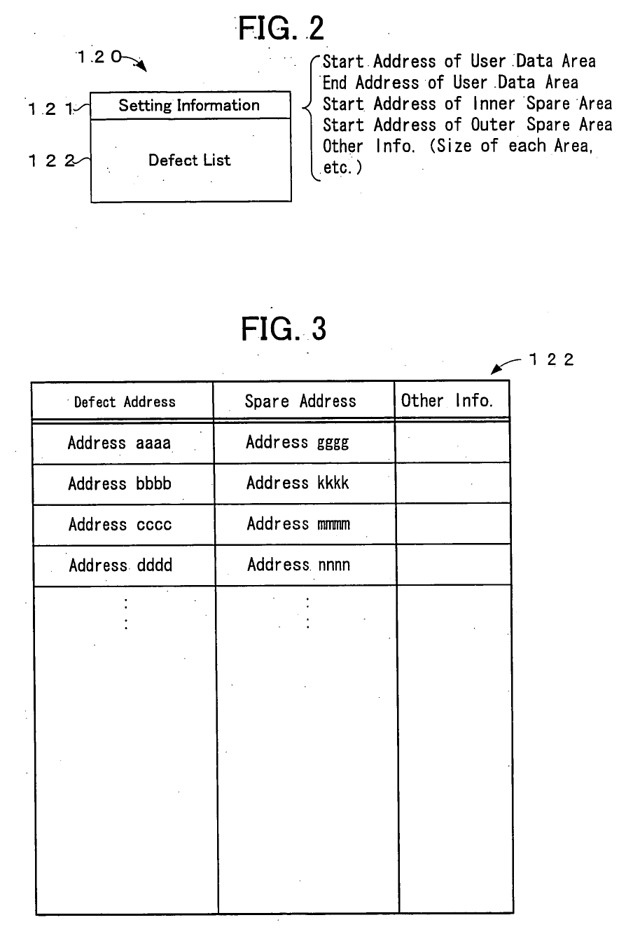

In each of the lead-in area 101 and the lead-out area 103, there are recorded control information for controlling and management information for managing the recording and reading of the information or data with respect to the optical disc 100. The lead-in area 101 is provided with a definite defect management area 106. The lead-out area 103 is also provided with a definite defect management area 107. In each of the definite defect management areas 106 and 107, there is recorded defect management information 120 (refer to FIG. 2).

The record data, such as image data, audio data and content data, is recorded into the data zone 102. The data zone 102 is provided with a user data area 108, and spare areas 109 and 110 are located on the inner and outer circumferential sides thereof. The user data area 108 is a main area to record therein the record data. The spare areas 109 and 110 are alternative recording areas (i.e. spare areas) to evacuate the record data from a defect in the user data area 108. In other words, if there is a defect in the user data area 108, the record data to be recorded or already recorded at the position of the defect (hereinafter such record data is referred to as “evacuation data”, as occasion demands) is alternatively recorded into the spare area 109 or 110.

The defect management information 120 is temporarily recorded into each of the temporary defect management areas 104 and 105. Incidentally, the defect management information 120 is also recorded into each of the definite defect management areas 106 and 107. A difference in the definite defect management areas 106 and 107 and the temporary defect management areas 104 and 105 will be discussed later.

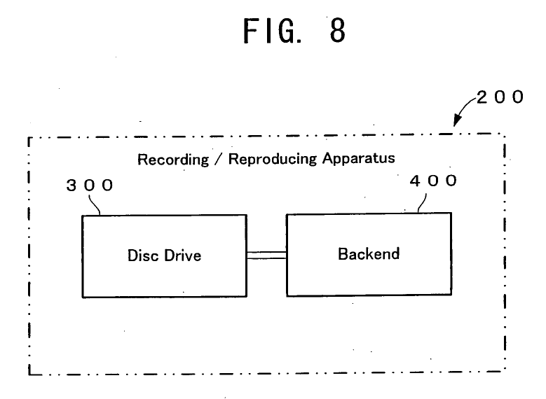

Next, the defect management information 120 will be discussed. The defect management information 120 is information used for the defect management performed by a recording/reproducing apparatus 200 (refer to FIG. 8). The recording/reproducing apparatus 200 performs the defect management when recording the record data onto the optical disc 100 or when reproducing the record data from the optical disc 100. In the embodiment, the defect management is mainly as follows. If there is a defect, such as scratches, dusts or deterioration, on the user data area 108 of the optical disc 100, the record data is recorded away from the position of the defect. At the same time, the evacuation data is recorded into the spare area 109 or 110. Moreover, the following processes are also performed as a part of the defect management: i.e., the process of recognizing the position of a defect upon reproducing the record data recorded on the optical disc 100; and the process of reading the record data to be originally recorded or already recorded at the position of the defect, from the spare area 109 or 110. In order to perform such defect management, the recording/reproducing apparatus 200 needs to recognize the presence position or the like of the defect in the user data area 108. The defect management information 120 is mainly used for the recording/reproducing apparatus 200 to recognize the presence position or the like of the defect.

FIG. 2 shows the content of the defect management information 120. As shown in FIG. 2, the defect management information 120 includes setting information 121 and a defect list 122.

As shown in FIG. 2, the setting information 121 includes: the start address of the user data area 108; the end address of the user data area 108; the start address of the inner spare area 109; the start address of the outer spare area 110; and other information (e.g. the sizes of the areas, etc.).

FIG. 3 shows the content of the defect list 122. As shown in FIG. 3, on the defect list 122, there are recorded an address for indicating the position of a defect in the user data area 108 (which is hereinafter referred to as a “defect address”), an address for indicating the recording position in the spare area 109 or 110 of the record data to be recorded or already recorded at the position of the defect (which is hereinafter referred to as a “spare address” (i.e. “spare recording address”)); and other information In other words, the defect address indicates one example of the “evacuation source address” of the present invention, and the spare address indicates one example of the “evacuation destination address” of the present invention. If there are a plurality of defects in the user data area 108, a plurality of defect addresses corresponding to the defects and a plurality of spare addresses are recorded onto the defect list 122.

Incidentally, the defect management can be performed not only in the user data area 108 of the optical disc 100 but also on the entire recording surface of the optical disc 100.

Next, the recording aspect of the defect management information 120 will be discussed. All the temporary defect management areas 104 and 105 and the definite defect management areas 106 and 107 are areas to record therein the defect management information 120; however, the temporary defect management areas 104 and 105 and the definite defect management areas 106 and 107 have differences in location, size, and purpose for use. The differences of the both areas will be discussed below.

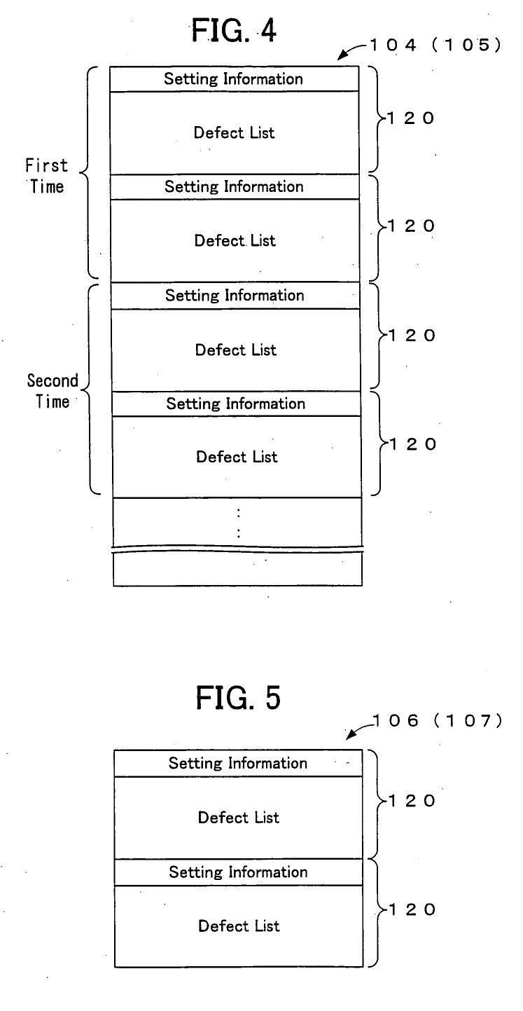

FIG. 4 shows one example of a state in which the defect management information 120 is recorded in the temporary defect management area 104 or 105. The temporary defect management areas 104 and 105 are areas to temporarily record therein the defect management information 120 until the optical disc 100 is finalized. The defect management information 120 is information necessary for the defect management. The presence or absence of a defect and its position differ on the individual optical disc, so that it is necessary to hold the defect management information on the individual optical disc. In the embodiment, before the finalizing, the defect management information 120 is recorded in the temporary defect management area 104 or 105 of the optical disc 100.

Moreover, in the embodiment, as shown in FIG. 4, it is preferable to record the defect management information 120 into the temporary defect management area 104 or 105, repeatedly, twice (incidentally, since FIG. 4 shows a state in which the repetitive recording of the defect management information 120 is performed twice, four defect management information 120 in total are illustrated). By this, it is possible to surely record and surly reproduce the defect management information 120. Even if not recorded twice, for example, recorded once or recorded three time or more, the defect management information 120 and the evacuation data can be recorded and reproduced, properly.

There is a case where the defect management information 120 is updated several times until the optical disc 100 is finalized. For example, if some dust is attached to the optical disc 100 between the first recording and the second recording (additional recording), the defect (dust) is detected upon the second recording, and on the basis of this, the defect list 122 is updated. If the defect list 122 is updated, the defect management information 120 including the updated defect list 122 is additionally recorded or written once into the temporary defect management area 104 or 105. Since the optical disc 100 is a write-once-type recording medium, it is impossible to record the updated defect management information 120 over the existing defect management information 120. Thus, as shown in FIG. 4, the updated defect management information 120 is recorded continuously after the existing defect management information 120.

In order to realize such repetitive and parallel recording of the defect management information 120, the temporary defect management areas 104 and 105 are larger than the definite defect management areas 106 and 107.

On the other hand, FIG. 5 shows one example of a state in which the defect management information 120 is recorded in the definite defect management area 106 or 107. The definite defect management areas 106 and 107 are areas to definitely record therein the defect management information 120 when the optical disc 100 is finalized. In other words, before the finalizing, the definite defect management areas 106 and 107 are unrecorded. After the finalizing, the defect management information 120 is recorded into the definite defect management areas 106 and 107, and after that, the recording state is remained.

In the embodiment, as shown in FIG. 5, it is preferable to record the defect management information 120 into the definite defect management area 106 or 107, repeatedly, twice. By this, it is possible to surely record and surly reproduce the defect management information 120. Even if not recorded twice, for example, recorded once or recorded three time or more, the defect management information 120 can be recorded and reproduced, properly.

According to the optical disc 100 in the embodiment, the temporary defect management area 104 is disposed between the lead-in area 101 and the data zone 102, and the temporary defect management area 105 is disposed between the data zone 102 and the lead-out area 103, so that it is possible to provide compatibility between the write-once-type optical disc 100 and a general rewritten-type optical disc. Because there needs to be the lead-in area, the data zone, and the lead-out area and there is a need to maintain the basic recording structure, such as the order, location and size (dimensions) of the areas, in order to realize the compatibility with the rewritten-type optical disc. In the optical disc 100, although it is provided with the temporary defect management areas 104 and 105, the optical disc 100 maintains the basic recording structure. In other words, if the temporary defect management area 104 is disposed in the lead-in area 101, there arises such a disadvantage that the size of the lead-in area 101 is to be expanded because the temporary defect management area 104 is relatively large, as described above. In the embodiment, however, the temporary defect management area 104 is disposed out of the lead-in area 101, which does not cause such a disadvantage. Moreover, if the temporary defect management areas 104 is disposed in the data zone 102, there arises such a disadvantage that the defect management information 120, which has a character of the control information, is mixed into the data zone 102 which is an area to record therein the record data, and the information with different characters, such as the control information and the record data, is mixed in the data zone 102. In the embodiment, since the temporary defect management area 104 is disposed out of the data zone 102, such a disadvantage does not occur. The same is true for the temporary defect management area 105.

Incidentally, the start address and end address of the user data area 108, the start address of the spare area 109 and the start address of the spare area 110 (or the sizes of the user data area 108 and the spare areas 109 and 110, etc.) are included in the setting information 121 of the defect management information 120 (refer to FIG. 2). Then, the setting information 121 can be set by the recording/reproducing apparatus 200. In other words, the start address and end address of the user data area 108, the size of the spare area 109 and the size of the spare area 110 are allowed to be changed, if expressed as the setting information 121. Even if the start address and end address of the user data area 108, the size of the spare area 109 and the size of the spare area 110 are changed, it is possible to maintain the compatibility with the general rewritable-type recording medium. Therefore, if the start address of the user data area 108 is shifted backward (to the outer circumferential side), it is possible to ensure or reserve a space between the lead-in area 101 and the data zone 102, and dispose the temporary defect management area 104 in the space. Moreover, depending on how to set the start address of the user data area 108, it is possible to reserve the temporary defect management area 104 which is relatively large (of a relatively large size). The same is true for the temporary defect management area 105.

Moreover, according to the optical disc 100 in the embodiment, the definite defect management areas 106 and 107 are disposed in the lead-in area 101 and the lead-out area 103, respectively, so that it is possible to provide the compatibility between the write-once-type optical disc 100 and the general rewritten-type optical disc. In other words, on the general rewritten-type optical disc, an area to record the defect management information is disposed in both the lead-in area and the lead-out area thereof. Then, even on the optical disc 100, the definite defect management areas 106 and 107 are disposed in the lead-in area 101 and the lead-out area 103. In this point, the both disc has the same recording structure. Therefore, it is possible to provide the compatibility between the write-once-type optical disc 100 and the general rewritten-type optical disc.

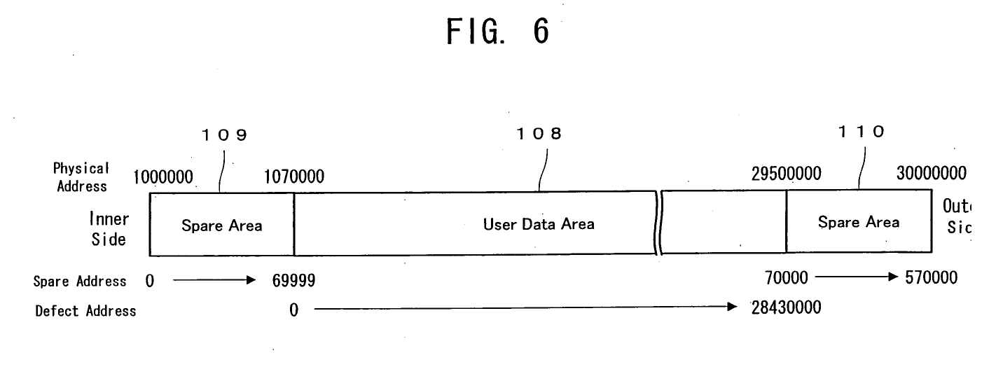

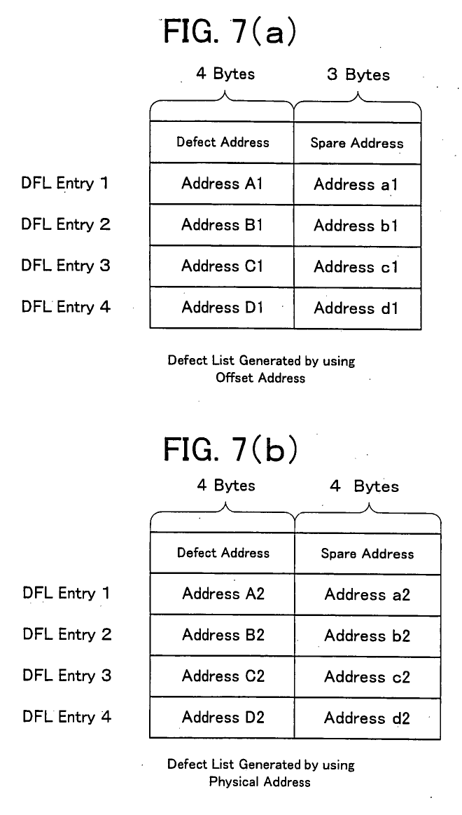

Next, with reference to FIG. 6 and FIG. 7, the recording and preparation aspects of the defect address and the spare address will be discussed, with a specific example shown. FIG. 6 is a schematic diagram conceptually showing a relationship between the data structure of the data zone 102 of the optical disc 100 and the address thereof. FIG. 7 are lists, each conceptually showing an example of the defect list.

As shown in FIG. 6, the data zone 102 occupies a recording area indicated by physical addresses of “1000000” to “30000000”, for example.

In the embodiment, the physical address is converted to an offset address based on a predetermined position in the spare area 109 (110), to thereby express the spare address by using the offset address. In addition, the physical address is converted to an offset address based on a predetermined position in the user data area 108, to thereby express the defect address by using the offset address. This will be specifically explained below.

It is assumed that the start point of the spare area 109 is designated, as a reference point of the spare area 109 (110). In this case, the offset address is determined on the basis of a location from the start point of the spare area 109. In other words, the offset address of the start address of the spare area 109 is “0”. Then, as shown in FIG. 6, if two spare areas are provided, the two spare areas are preferably combined and regarded as one spare area, to thereby determine the offset address. Therefore, the offset address of the end point of the spare area 109 and the offset address of the start point of the spare area 110 preferably have continuous values (i.e. the end point of the spare area 109=“69999”, the start point of the spare area 110=“70000h”).

Here, the spare address indicated by the physical address takes any value of “1000000” to “1070000” and “29500000” to “30000000”. However, by using the offset address as described above, the spare address takes any value of “0” to “570000”.

On the other hand, it is assumed that the start point of the user data area 108 is designated, as a reference point of the user data area 108. In this case, the offset address is determined from a position from the start point of the user data area 108. In other words, the offset address of the start address of the user data area 108 is “0”.

The defect address indicated by the physical address takes any value of “1070000” to “29500000”. By using the offset address as described above, the defect address takes any value of “0” to “28430000”.

Incidentally, the address of the start point of the spare area 109 and the address of the start point of the user data area 108, which are reference points, are included in the setting information 121 (refer to FIG. 2). Moreover, even if another point is designated as the reference point, information, such as an address for indicating the another point, is preferably included in the setting information 121.

Then, by using the offset address, as shown in FIG. 7(a), it is possible to specify one defect address with a data amount of 4 bytes and specify one spare address with a data amount of 3 bytes.

On the other hand, if the physical address is used, as shown in FGI. 7(b), it is possible to specify the defect address and the spare address only if each of them has a data amount of 4 bytes.

Therefore, by using the offset address, it is possible to reduce a data amount of 1 byte for each entry (a pair of one defect address and one spare address).

Then, the effect is greater in an optical disc having a recording capacity of about 25 GB in a single layer and about 50 GB in two layers, as in a large-capacity optical disc using blue laser, for example. Specifically, it is possible to reduce a data amount of about 272 mega bytes on the two-layer optical disc as a whole, by using the offset address, for example. In other words, it is possible to achieve the effect that the recording capacity of the data zone 102 increases by about 272 mega bytes.

In addition, as the information amount required for recording one address is larger, it takes shorter time to overflow 1 cluster (64 kilo bytes). If the overflow occurs, an additional cluster is necessary to record the whole defect list, so that it is desirable not to overflow as much as possible. In such a circumstance, it is possible to reduce the frequency of cluster overflow, by reducing the information amount required for recording one address.

Incidentally, as for the defect address in the example in FIG. 6, the data amount does not change in the case where the physical address is used for preparation and in the case where the offset address is used. In such a case, the defect address may be prepared by using the physical address or by using the offset address.

### Embodiment of Recording/Reproducing Apparatus

Next, the structure of the recording/reproducing apparatus in the embodiment of the present invention will be discussed. FIG. 8 shows the recording/reproducing apparatus 200, which is an embodiment of the present invention. The recording/reproducing apparatus 200 has a function of recording the record data onto the optical disc 100 and a function of reproducing the record data recorded on the optical disc 100.

The recording/reproducing apparatus 200 is provided with: a disc drive 300; and a backend 400.

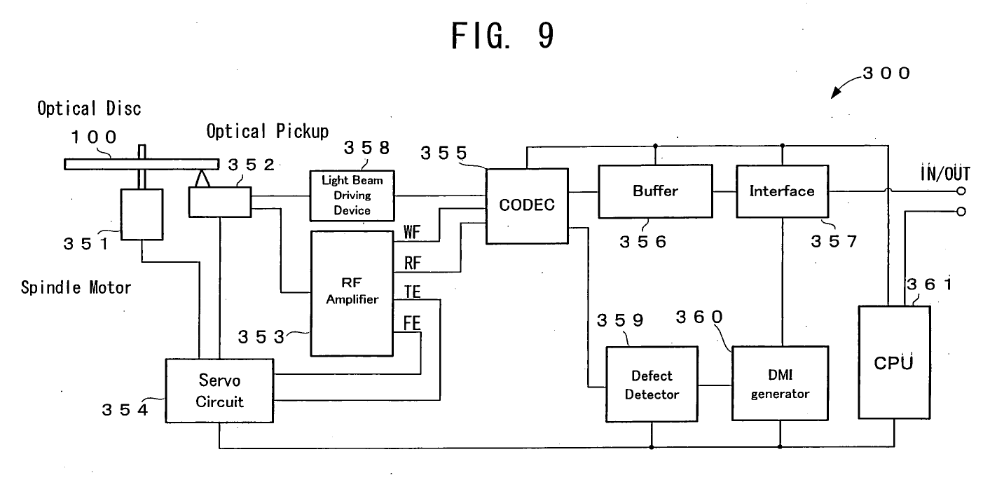

FIG. 9 shows the inner structure of the disc drive 300. The disc drive 300 is an apparatus for recording information onto the optical disc 100 and reading the information recorded on the optical disc 100.

As shown in FIG. 9, the disc drive 300 is provided with: a spindle motor 351; an optical pickup 352; a Radio Frequency (RF) amplifier 353; and a servo circuit 354.

The spindle motor 351 is a motor for rotating the optical disc 100.

The optical pickup 352 records the record data or the like onto the recording surface of the optical disc 100 by irradiating the recording surface with a light beam, and reads the record data or the like recorded on the recording surface by receiving the reflected light of the light beam. The optical pickup 352 outputs a RF signal corresponding to the reflected light of the light beam.

The RF amplifier 353 amplifies the RF signal outputted from the optical pickup 352 and outputs it to a Coder/Decoder (CODEC) 355. Moreover, the RF amplifier 353 generates, from the RF signal, a wobble frequency signal WF, a track error signal TE, and a focus error signal FE, and outputs them.

The servo circuit 354 is a servo control circuit for controlling the driving of the optical pickup 352 and the spindle motor 351 on the basis of the track error signal TE, the focus error signal FE, and other servo control signals.

Moreover, as shown in FIG. 9, the disc drive 300 is provided with: the CODEC 355; a buffer 356; an interface 357; and a light beam driving device 358.

The CODEC 355 is a circuit, provided with: a function of performing an error correction for the record data upon reading; and a function of appending an error correction code or mark to the record data upon recording so as to modulate the record data. Specifically, upon reading, the CODEC 355 demodulates and decodes the RF signal outputted from the RF amplifier 353, performs an error correction for the decoded RF signal, and then outputs this to the buffer 356. Moreover, if the error correction is impossible as a result of performing the error correction for the decoded RF signal, the CODEC 355 generates an error-correction-impossible signal for indicating that, and outputs this signal to a defect detector 359. Upon recording, the CODEC 355 appends the error correction code to the record data outputted from the buffer 356, modulates this data to have a code suited to the optical characteristics or the like of the optical disc 100, and then outputs the modulated record data to the light beam driving device 358.

The buffer 356 is a memory circuit for storing the record data temporarily.

The interface 357 is a circuit for controlling the input/output or communication of the record data or the like between the disc drive 300 and the backend 400. Specifically, upon reproducing, the interface 357 responds a request command from the backend 400, and outputs the record data outputted from the buffer 356 (i.e. the record data read from the optical disc 100) to the backend 400. Upon recording, the interface 357 receives the record data which is inputted from the backend 400 to the disc drive 300, and outputs this data to the buffer 356. The interface 357 responds the request command from the backend 400 and outputs all or part of the defect lists maintained in a generator 360 for generating Defect Management Information (DMI generator 360) to the backend 400.

Upon recording, the light beam driving device 358 generates a light beam driving signal corresponding to the record data outputted from the CODEC 355 and outputs this signal to the optical pickup 352. The optical pickup 352 modulates a light beam on the basis of the light beam driving signal, and irradiates the recording surface of the optical disc 100 with it. This causes the recording of the record data or the like onto the recording surface.

Moreover, as shown in FIG. 9, the disc drive 300 is provided with: the defect detector 359; and the DMI generator 360.

The defect detector 359 is a circuit for detecting a defect on the optical disc 100. The defect detector 359 generates a defect detection signal for indicating the presence or absence of a defect, and outputs this signal. The defect detector 359 detects a defect on the basis of the result of the error correction of the record data upon reading information (upon verifying or reproducing). As described above, if the error correction is impossible as a result of performing the error correction for the decoded RF signal, the CODEC 355 generates the error correction impossible signal for indicating the fact, and outputs this signal to the defect detector 359. The defect detector 359 outputs the defect detection signal for indicating the presence of a defect when receiving this error correction impossible signal.

Moreover, upon reproducing, even before the error correction is impossible as a result of performing the error correction for the decoded RF signal, if an error over a certain reference value occurs, it is preferable to construct the CODEC 355 to generate an error-correction-impossible signal for indicating the fact.

The DMI generator 360 is a circuit for generating or updating the defect management information 120 on the basis of the defect detection signal outputted from the defect detector 359. The defect management information 120 is rewritably stored into a memory circuit located in the DMI generator 360. The DMI generator 360 responds to the request command from the backend 400 and outputs the defect management information 120 to the backend 400 through the interface 357.

Moreover, as shown in FIG. 9, the disc drive 300 has a Central Processing Unit (CPU) 361. The CPU 361 controls the disc drive 300 as a whole, and controls the exchange of information among the elements in the disc drive 300 described above. The CPU 361 also controls the recording operation and reading operation of the record data and the defect management information 120. The CPU 361 also responds to the control command or the request command transmitted from the backend 400, and controls the exchange of data between the disc drive 300 and the backend 400.

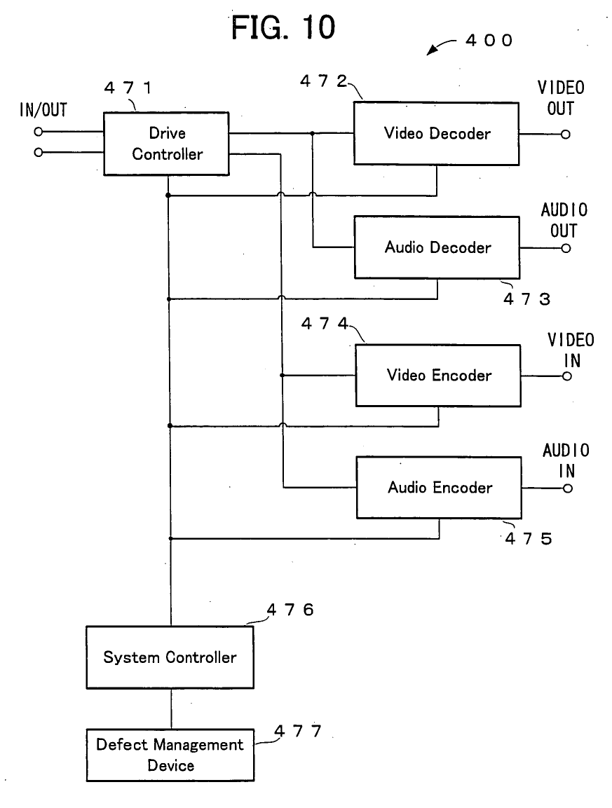

Next, FIG. 10 shows the inner structure of the backend 400. The backend 400 is an apparatus for performing a reproduction process with respect to the record data read by the disc drive 300 from the optical disc 100, receiving the record data supplied from the outside in order to record it onto the optical disc 100, encoding this record data, and transmitting it to the disc drive 300.

The backend 400 is provided with: a drive controller 471; a video decoder 472; an audio decoder 473; a video encoder 474; an audio encoder 475; a system controller 476; and a defect management device 477.

The drive controller 471 is a circuit for controlling the reading process and recording process of the disc drive 300. The backend 400 and the disc drive 300 cooperate and perform an operation of reading the record data from the optical disc 100 and reproducing it and an operation of receiving the record data from the outside and recording it onto the optical disc 100. The drive controller 471 realizes the cooperation of the backend 400 and the disc drive 300 by controlling the reading process and recording process of the disc drive 300. Specifically, the drive controller 471 outputs to the disc drive 300 request commands about reading, recording, outputting the record data from the buffer 356, outputting the defect management information 120 from the DMI generator 360 and so on. The drive controller 471 also controls the input and output of the record data, the defect management information 120, and other various information.

The video decoder 472 and the audio decoder 473 are circuits for decoding the record data which is read from the optical disc 100 by the disc drive 300 and which is supplied through the drive controller 471, and converting the record data to be reproducible with a display, a speaker, or the like.

The video encoder 474 and the audio encoder 475 are circuit for receiving a video signal, an audio signal, or the like, inputted from the outside for the purpose of recording them on the optical disc 100, compressing and encoding them by Moving Picture Experts Group (MPEG) compressing and encoding method or the like, and supplying them to the disc drive 300 through the drive controller 471.

The system controller 476 is a circuit for controlling: the drive controller 471; the video decoder 472; the audio decoder 473; and the defect management device 477, and performing the reproduction process of the record data in cooperation with the devices, upon reproducing. Upon recording, the system controller 476 controls: the drive controller 471; the video encoder 474; the audio encoder 475; and the defect management device 477, to thereby record the record data in cooperation with the devices. Upon reproducing and recording, the system controller 476 controls the disc drive 300 (e.g. controls the generation and transmission of various request commands, the reception of a response signal, or the like) with the drive controller 471 in order to realize the cooperation of the disc drive 300 and the backend 400.

The defect management device 477 has therein a memory circuit, and has a function of receiving and maintaining all or part of the defect management information 120 generated or updated by the DMI generator 360 in the disc drive 300. The defect management device 477 performs the defect management with the system controller 476.

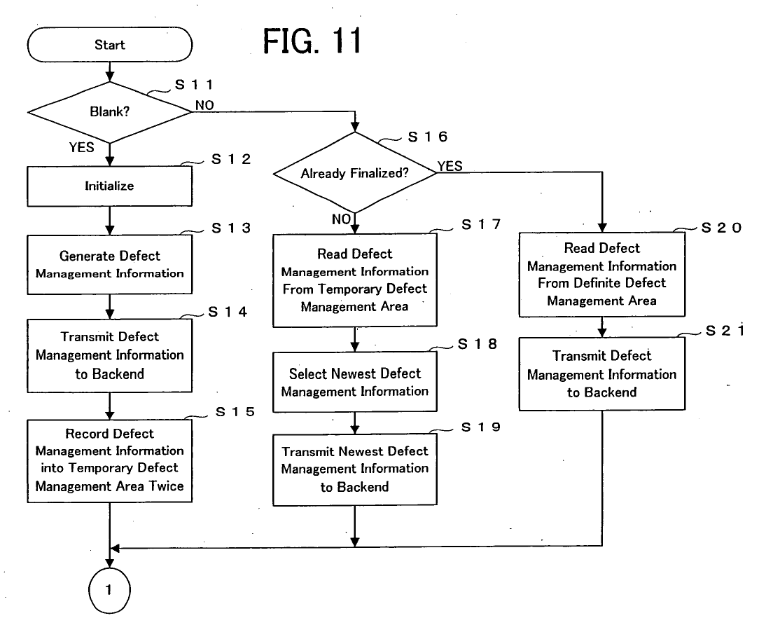

Next, the initial setting operation of the recording/reproducing apparatus 200 will be explained. FIG. 11 shows the initial setting operation of the recording/reproducing apparatus 200. The recording/reproducing apparatus 200 performs the initial setting between (i) when the optical disc 100 is inserted or loaded in the drive unit 300 and (ii) when the record data is recorded or reproduced. The initial setting is a process for preparing for the recording or the reproduction of the record data, and includes various processes. Out of the various processes, the initialization of the optical disc 100, the generation of the defect management information 120, the transmission of the defect management information 120 to the backend 400, or the like will be explained below. The process is performed mainly under the control of the CPU 361 of the drive unit 300.

As shown in FIG. 11, when the optical disc 100 is inserted or loaded into the drive unit 300, the CPU 361 of the drive unit 300 judges whether or not the optical disc 100 is an unrecorded disc (i.e. a blank disc) (step S11).

If the optical disc 100 is a blank disc (the step S11: YES), the CPU 361 initializes the optical disc 100 (step S12). In this initialization, the DMI generator 360 generates the defect management information 120 (step S13). Specifically, it obtains the start address and end address of the user data area 108 and the areal sizes of the spare areas 109 and 110, which are set in the initialization, and generates the setting information 121. Moreover, it also generates the defect list 122. The defect list 122 generated at this time has only an outline or frame, not having any content. Namely, the defect address is not recorded in it, nor is the specific spare address. A header, identification or discrimination information or the like are only recorded. The generated defect management information 120 is stored and maintained in the DMI generator 360.

Then, the CPU 361 transmits the defect management information 120 stored in the DMI generator 360, to the backend 400 (step S14). The defect management information 120 is stored into the defect management device 477 of the backend 400.

Then, the CPU 361 records the defect management information 120 stored in the DMI generator 360, into the temporary defect management area 104 or 105 on the optical disc 100, repeatedly, twice (step S15).

On the other hand, if the optical disc 100 is not a blank disc (the step S11: NO), then, the CPU 361 judges whether or not the optical disc 100 is already finalized (step S16). The finalizing is a process for arranging (or organizing) a recording format of the optical disc 100, to reproduce the record data on the optical disc 100 by using a reproducing apparatus for a general rewritable-type optical disc and a reproducing apparatus for a general reproduce-only-type optical disc. It is possible to know whether of not the optical disc 100 is already finalized, with reference to the control information recorded in the lead-in area 101 or the like on the optical disc 100.

If the optical disc 100 is not finalized (the step S16: NO), the CPU 361 reads the defect management information 120 from the temporary defect management area 104 or 105 on the optical disc 100 (step S17). Namely, if the optical disc 100 is not a blank disc, the defect management information 120 which are already generated in the past are recorded in the temporary defect management area 104 or 105, so that this is read in this step.

If a plurality of defect management information 120 is recorded in the temporary defect management area 104 or 105, the CPU 361 selects and reads the newest defect management information from among them (step S18). In other words, before the finalizing, the defect management information 120 is recorded into the temporary defect management area 104 or 105 every time the defect management information 120 is updated. The plurality of defect management information 120 is arranged, continuously, in the updated order. Therefore, the defect management information located in the end in the temporary defect management area 104 or 105 is the newest defect management information. The CPU 361 selects and reads the defect management information located in the end.

The embodiment adopts the following manner in order to specify the defect management information 120 located in the end. Namely, if the plurality of defect management information 120 is continuously arranged and recorded in the temporary defect management area 104 or 105, information is recorded from the start address of the temporary defect management area 104 or 105 to the end address of the area where the last defect management information 120 is recorded, and it is unrecorded after the end address. The CPU 361 controls the optical pickup 352 to scan the temporary defect management area 104 or 105 from the start address thereof, to thereby detect a position at which it becomes the unrecorded state, and to scan the temporary defect management area 104 or 105 from the position in the opposite direction. In this manner, the last defect management information 120 is specified. According to this method, it is possible to simply specify the last defect management information 120 without a pointer or the like.

Then, the CPU 361 stores the read last defect management information 120 into the DMI generator 360 and transmits this information to the backend 400 (step S19). The last defect management information 120 is stored in the defect management device 477 of the backend 400.

On the other hand, if the optical disc 100 is not a blank disc but is already finalized (the step S16: YES), the CPU 361 reads the defect management information 120 from the definite defect management area 106 or 107 (step S20), and transmits this information to the backend 400 (step S21). The defect management information 120 is stored into the defect management device 477 of the backend 400.

In the above manner, the defect management information 120 is generated, or the defect management information 120 is selectively read from the temporary defect management area 104 or 105, or the defect management information 120 is selectively read from the definite defect management area 106 or 107. Then, the defect management information 120 is stored into the DMI generator 360 and the defect management device 477 of the backend 400. By this, the defect management is prepared, to thereby end the initial setting.

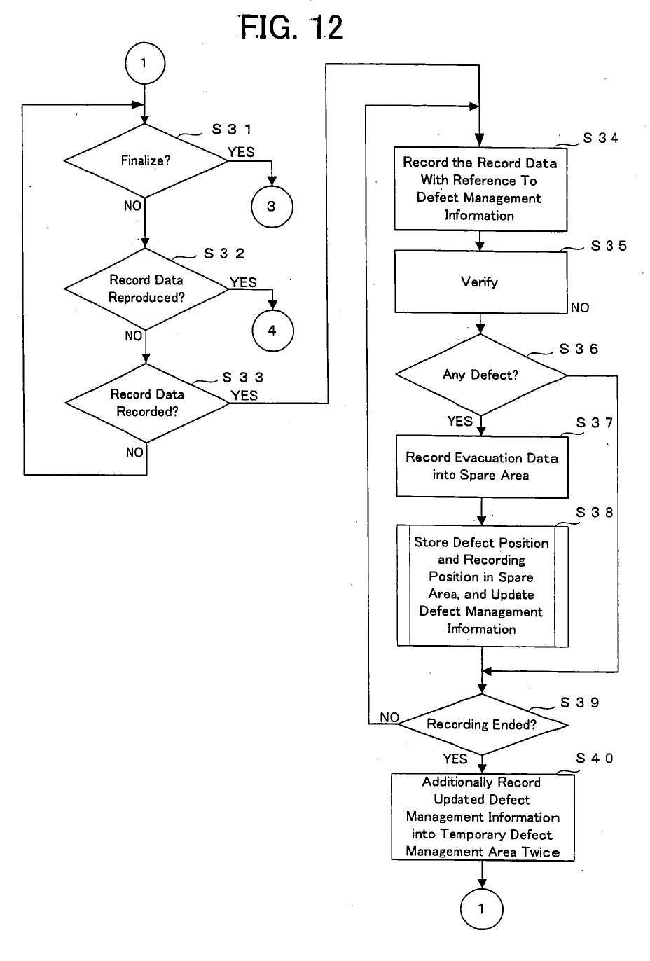

Next, the recording operation of the recording/reproducing apparatus 200 will be explained. FIG. 12 mainly shows the recording operation of the recording/reproducing apparatus 200. The recording/reproducing apparatus 200 performs the recording operation of recording the record data into the user data area 108 on the optical disc 100. The recording/reproducing apparatus 200 also performs verifying during the recording operation, and updates the defect list 122 on the basis of the result of the verifying. The recording operation is realized by the cooperation of the CPU 361 of the disc drive 300 and the system controller 476 of the backend 400.

As shown in FIG. 12, if a user inputs an instruction to start recording (step S33: YES), the recording/reproducing apparatus 200 responds to this and records the record data (step S34). The record data is recorded into each predetermined block. The recording/reproducing apparatus 200 refers to the defect management information 120 stored in the defect management device 477 of the backend 400, and records the record data while performing the defect management on the basis of this defect management information 120.

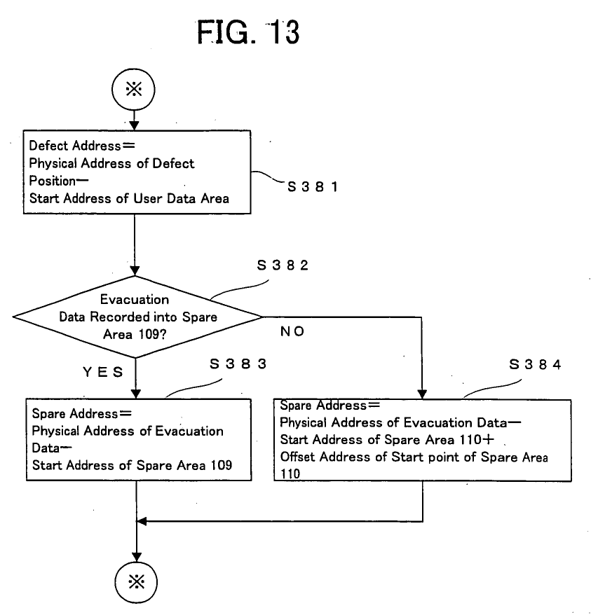

The recording/reproducing apparatus 200 performs verifying at each time of the one block recording is ended or every time a series of writing sequence is ended (step S35), and updates the defect management information 120 on the basis of the result of the verifying. Incidentally, the defect management information 120 to be updated is the defect management information 120 stored in the DMI generator 360. Specifically, if it is recognized, as a result of the verifying, that the record data fails to be recorded (step S36: YES), the CPU 361 records the record data that fails to be recorded, into the spare area 109 or 110 (step S37). Then, the CPU 361 estimates that there is a defect in a place in which the record data is supposed to be recorded, and records the defect address for indicating the place and the corresponding spare address onto the defect list 122 (step S38). The generation operation of the defect address and the spare address herein will be discussed in detail later (refer to FIG. 13).

When the processes in the above-described steps S34 to S38 ends with respect to a series of blocks of the record data to be recorded this time (step S39: Yes), the CPU 361 records the updated defect management information 120 into the temporary defect management area 104 or 105 on the optical disc 100, repeatedly twice (step S40). At this time, the defect management information 120 to be recorded into the temporary defect management area 104 or 105 is the defect management information 120 stored in the DMI generator 360. Then, the recording operation is completed.

Then, the updating operation of the defect management information in the step S38 in FIG. 12 (the generation of the defect address and the spare address) will be discussed in more detail with reference to FIG. 13. FIG. 13 is a flowchart showing an operation example related to the generation of the defect address and the spare address upon updating the defect management information. Incidentally, the optical disc 100 which shows the data structure and the physical address shown in FIG. 6 will be discussed, more specifically.

As shown in FIG. 13, at first, the DMI generator 360 calculates the defect address by operation, for example, under the control of the CPU 361 (step S381). In this case, the DMI generator 360 calculates the defect address by subtracting the start address of the user data area 108 from the physical address of a position where a defect occurs (in FIG. 6, “1070000”). In other words, the defect address which is calculated here is the offset address with the start address of the user data area 108 as a reference point. For example, if there is a defect at a position with a physical address of “1320000”, the defect address of the defect expressed by the offset address is “13200000”−“1070000”=“250000”.

Incidentally, the operation may be sequentially performed upon the recording of the record data in the step S34 in FIG. 12, and may be held in a memory, such as a RAM. In this case, in the step S381, the DMI generator 360 preferably obtains the defect address held in the memory. Alternatively, the defect address may be calculated in another operation method.

Then, the DMI generator 360 judges whether a destination to which the evacuation data is recorded is in the spare area 109 or the spare area 110 (step S382). If the value of the physical address at which the evacuation data is recorded is greater than the value of the start address of the spare area 110 (“29500000” in FIG. 6), it is judged that the evacuation data is recorded in the spare area 110. On the other hand, if the value of the physical address at which the evacuation data is recorded is less than the value of the start address of the spare area 110, it is judged that the evacuation data is recorded in the spare area 109. For example, if the evacuation data is recorded at a position with the physical address expressed by “1050000”, inequality of “1050000”<“29500000” holds true. Thus, it is judged that the evacuation data is recorded in the spare area 109.

Incidentally, even if not performed in this manner, the judgment may be performed in advance upon the recording operation of the evacuation data in the step S37 in FIG. 12, or may be performed in another operation method.

As a result of the judgment, if the evacuation data is recorded in the spare area 109 (the step S382: YES), the DMI generator 360 calculates the spare address in the spare area 109, under the control of the CPU 361 (step S383). In this case, the spare address is calculated by subtracting the start address of the spare area 109 (“1000000” in FIG. 6) from the value for indicating the physical address in the spare area 109 at which the evacuation data is recorded, for example. In other words, the spare address calculated here is the offset address based on the start address of the spare area 109. For example, if the evacuation data is recorded at a position with the physical address expressed by “1050000”, the spare address expressed by the offset address is “1050000”−“1000000”=“50000”.

On the other hand, if the evacuation data is recorded in the spare area 110 (the step S382: NO), the DMI generator 360 calculates the spare address in the spare area 110, under the control of the CPU 361 (step S384). In this case, the spare address is calculated by subtracting the start address of the spare area 110 (“29500000” in FIG. 6) from the value for indicating the physical address in the spare area 110 at which the evacuation data is recorded, and also by adding the offset address of the start point of the spare area 110 (“70000h” in FIG. 6). For example, if the evacuation data is recorded at a position with the physical address expressed by “29800000”, the spare address expressed by the offset address is “29800000”−“295000000”+“70000h”=“370000”.

Incidentally, even if the spare address is not calculated as shown in the step S383 or the step S384, the address operation may be performed upon the recording of the evacuation data in the step S37 in FIG. 12, and it may be held in a memory, such as a RAM. In this case, in the step S383 or the step S384, the DMI generator 360 preferably obtains the spare address held in the memory. Alternatively, the spare address may be calculated in another operation method.

By virtue of the above operations, it is possible to generate the defect address and the spare address expressed by the offset address, and record them as the defect list 122 (the defect management information 120).

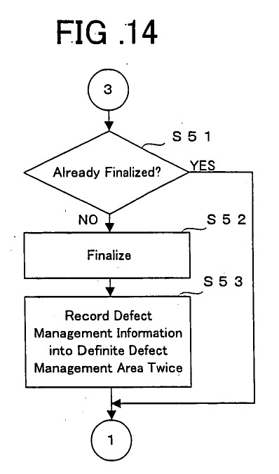

Next, the finalize process of the recording/reproducing apparatus 200 will be explained. FIG. 14 shows the finalize process. For example, if the user inputs an instruction for indicating to finalize (the step S31 in FIG. 12: YES), the recording/reproducing apparatus 200 confirms that the optical disc 100 is not finalized yet (step S51: YES) and finalizes the optical disc 100 (step S52). Upon finalizing, the recording/reproducing apparatus 200 records the defect management information 120 into the definite defect management area 106 or 107 on the optical disc 100, repeatedly twice (step S53). The recording may be performed once, or a plurality of times, such as three or more. Incidentally, the defect management information 120 to be recorded into the definite defect management area 106 or 107 is the defect management information 120 stored in the DMI generator 360. Then, the finalizing is completed.

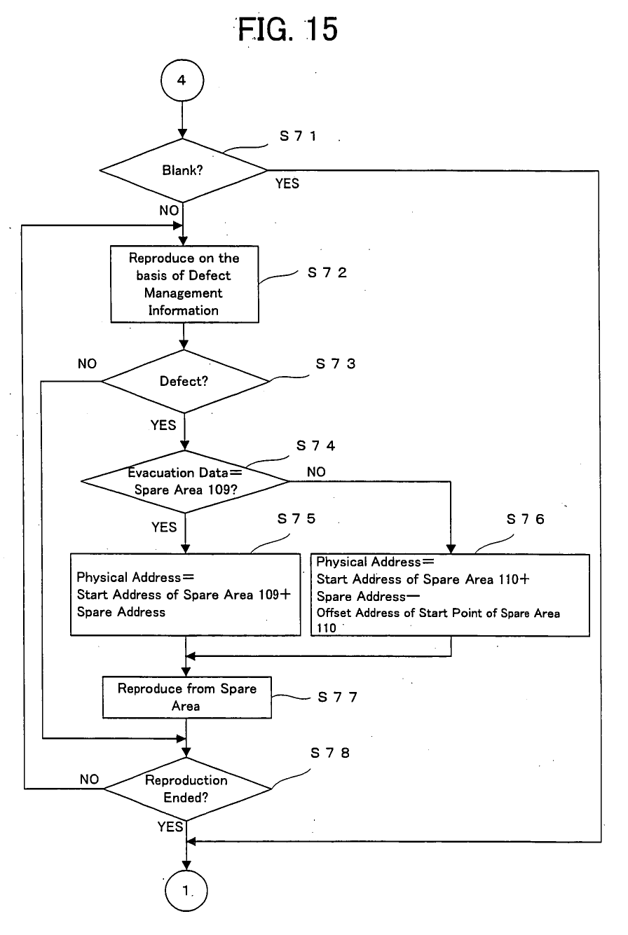

Next, the reproduction operation of the recording/reproducing apparatus 200 will be explained. FIG. 15 shows the reproduction operation of the recording/reproducing apparatus 200. Incidentally, even in the reproduction operation, the optical disc 100 which shows the data structure and the physical address shown in FIG. 6 will be discussed, more specifically.

If the user inputs an instruction to starting reproduction (the step S33: YES), the recording/reproducing apparatus 200 confirms that the optical disc 100 is not a blank disc (the step S71: NO), and reproduces the record data recorded in the user data area 108 on the optical disc 100 (step S72). The recording/reproducing apparatus 200 reproduces the record data, while performing the defect management on the basis of the defect management information 120 stored in the defect management device 477 of the backend 400.

During the reproduction of the record data, it is judged whether or not the user data are 108 which is sequentially reproduced corresponds to the position of a defect (step S73).

As a result of the judgment, if it is judged that it is the position of the defect (the step S73: YES), it is judged whether the record data to be recorded at the position of the defect (i.e. the evacuation data) is recorded in the spare area 109 or the spare area 110 (step S74). In this case, if the spare address expressed by the offset address is equal to or less than the offset address of the end point of the spare area 109 (“69999” in FIG. 6), it may be judged that the evacuation data is recorded in the spare area 109. On the other hand, if the spare address expressed by the offset address is greater than the offset address of the end point of the spare area 109, it may be also judged that the evacuation data is recorded in the spare area 110.

As a result of the judgment in the step S74, if it is judged that the evacuation data is recorded in the spare area 109, the physical address in the spare area 109 at which the evacuation data is recorded is calculated (step S75). In this case, the physical address is calculated by adding the spare address to the start address of the spare area 109 (“1000000” in FIG. 6). For example, if the spare address is expressed by “20000”, the physical address is “1000000”+“20000”=“1020000”.

On the other hand, as a result of the judgment in the step S74, if it is judged that the evacuation data is recorded in the spare area 110 (the step S74: NO), the address in the spare area 110 at which the evacuation data is recorded is calculated (step S76). In this case, the physical address is calculated by adding the spare address to the start address of the spare area 110 (“29500000” in FIG. 6) and by subtracting the offset address of the start point of the spare area 110 (“7000” in FIG. 6). For example, if the spare address is expressed by “90000”, the physical address is “90000”+“29500000”−“70000”=“29520000”.

Then, the evacuation data recorded at the position with the physical address calculated in the step S75 or the step S76 is reproduced (step S77).

Incidentally, if a new defect occurs during the reproduction, the defect management is sequentially performed, in accordance with the step S37 and the step S38 in FIG. 12 mentioned above.

Then, it is judged whether or not the reproduction is ended (step S78). If the reproduction is ended (the step S78: YES), the reproduction operation is ended. On the other hand, if the reproduction is not ended (the step S78: NO), the reproduction operation from the step S72 to the step S77 is continued, on the basis of the defect management information.

Incidentally, the above-mentioned various operations shown in the reproduction operation are merely one example. If it is possible to properly judge or calculate a proper address in each step, the judgment or calculation may be performed in another operation method.

Consequently, according to the recording/reproducing apparatus 200 in the embodiment, before finalizing the optical disc 100, the defect management information 120 is recorded into the temporary defect management area 104 or 105 of the optical disc 100. Upon finalizing the optical disc 100, the defect management information 120 is recorded into the definite defect management area 106 or 107 of the optical disc 100. With respect to the optical disc 100 which is not finalized, the defect management information 120 is read from the temporary defect management area 104 or 105 of the optical disc 100. With respect to the optical disc 100 which is already finalized, the defect management information 120 is read from the definite defect management area 106 or 107 of the optical disc 100. By this, with respect to the optical disc 100 which is not finalized and the optical disc 100 which is already finalized, it is possible to realize the recording or reproduction of the record data while performing the defect management properly.

In particular, the defect address and the spare address are expressed by the offset address. Thus, as compared to the case where the physical address is used to express them, it is possible to reduce the data amount of the defect address and the spare address. Therefore, it is possible to record more user data onto the optical disc 100 and properly reproduce it, while the defect management is performed properly. In particular, it is possible to achieve a greater effect (i.e. the reduction of the data amount related to the address expression, the increase of an available area for the recording of the record data, and so on) in a large-capacity information recording medium, such as the optical disc using the blue laser, Moreover, according to the recording/reproducing apparatus 200 in the embodiment, it records the defect management information 120 into the definite defect management area 106 or 107 of the optical disc 100 in the finalize process. Thus, it is possible to establish the compatibility between the write-once-type optical disc 100 and the general rewritable type optical disc.

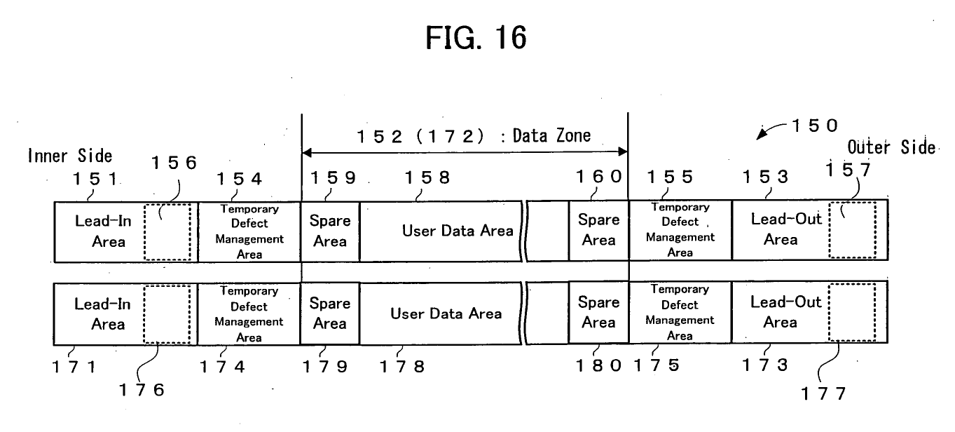

Incidentally, in the above-mentioned embodiments, such an example is given that the information recording medium of the present invention is applied to the optical disc with one layer. The present invention, however, is not limited to this example, and can be applied to an optical disc with two or more layers. FIG. 16 shows another embodiment in which the information recording medium of the present invention is applied to an optical disc with two layers. The first layer of a two-layer optical disc 150 in FIG. 16 (upper part in FIG. 16) is provided with: a lead-in area 151; a data zone 152; and a lead-out area 153, as in the optical disc 100, and is provided with: a temporary defect management area 154 between the lead-in area 151 and the data zone 152; and a temporary defect management area 155 between the data zone 152 and the lead-out area 153. Moreover, it is provided with definite management areas 156 and 157 in the lead-in area 151 and in the lead-out area 153, respectively, and provided with a user data area 158, and spare areas 159 and 160 in the data zone 152. The second layer is provided with: a lead-in area 171; a data zone 172; and a lead-out area 173, as in the optical disc 100, and is provided with: a temporary defect management area 174 between the lead-in area 171 and the data zone 172; and a temporary defect management area 175 between the data zone 172 and the lead-out area 173. Moreover, it is provided with definite management areas 176 and 177 in the lead-in area 171 and in the lead-out area 173, respectively, and provided with a user data area 178, and spare areas 179 and 180 in the data zone 172.

Incidentally, the drawings used for the explanation of the embodiments of the present invention embody constitutional elements or the like of the recording medium, the recording apparatus, and the reproducing apparatus of the present invention only for the purpose of explaining technical ideas thereof. The shape, size, position, connection relationship, and the like of various constitutional elements or the like are not limited to the drawings.

In addition, in the above-mentioned embodiments, the optical disc 100 is discussed as one example of the recording medium, and the recorder or player related to the optical disc 100 is discussed as one example of the recording/reproducing apparatus. Nevertheless, the present invention is not limited to the optical disc and the recorder or player thereof, but is applicable to other various information recording media and the recorders thereof which support high density recording or a high transfer rate.

The present invention can be changed if desired without departing from the scope or spirit of the invention which can be read from the claims and the entire specification. An information recording medium, a recording apparatus, a reproducing apparatus, a recording method, a reproducing method, and a computer program that realizes these functions, which accompany such changes, are also intended to be within the technical scope of the present invention.

### INDUSTRIAL APPLICABILITY

An information recording medium, a recording apparatus and a recording method for the information recording medium, a reproducing apparatus and a reproducing method for the information recording medium, a computer program for recording or reproduction control, and a data structure including a control signal of the present invention can be applied to a high-density optical disc, for consumer or industrial use, on which various information can be recorded at high density and further can be applied to a recorder and a player and the like related to the optical disc. Moreover, they can be applied to an information recording medium, a recording or reproducing apparatus, or the like, which are mounted on or can be connected to various computer equipment, for example.

1. An information recording medium comprising:
a data area to record therein record data;
a spare area to record therein evacuation data which is record data to be recorded at a position of a defect in said data area or which is record data recorded at the position; and
a temporary defect management area to temporarily record therein defect management information including at least an evacuation source address which is an address of the position and an evacuation destination address which is an address of a recording position of the evacuation data,
the evacuation destination address being specified by a first offset address based on one predetermined point in said spare area.

2. The information recording medium according to claim 1, further comprising a control information recording area to record therein information for controlling at least one of operations of recording and reading in said data area, said control information recording area including a definite defect management area to record therein defect management information of said data area.

3. The information recording medium according to claim 1, wherein the one point corresponds to a start point of said spare area.

4. The information recording medium according to claim 1, wherein a point defining information to define the one point is recorded.

5. The information recording medium according to claim 1, wherein the evacuation source address is specified by a second offset address based on another predetermined point in said data area.

6. The information recording medium according to claim 1, wherein
the information recording medium comprises a plurality of spare areas, and
the first offset address is an address which is bridged over the plurality of spare areas based on the one point defined by only one with respect to the plurality of spare areas

7. A recording apparatus for recording record data onto an information recording medium comprising: (i) a data area to record therein record data; (ii) a spare area to record therein evacuation data which is record data to be recorded at a position of a defect in said data area or which is record data recorded at the position; and (iii) a temporary defect management area to temporarily record therein defect management information including at least an evacuation source address which is an address of the position and an evacuation destination address which is an address of a recording position of the evacuation data,
said recording apparatus comprising:
a defect management information generating device for generating or updating the defect management information; and
a recording device for recording at least one of the record data, the evacuation data and the generated or updated defect management information,
said defect management information generating device generating the evacuation destination address which is specified by a first offset address based on one predetermined point in said spare area, to thereby generate or update the defect management information.

8. The recording apparatus according to claim 7, wherein said defect management information generating device generates or updates the defect management information with a start point of said spare area as the one point.

9. The recording apparatus according to claim 7, wherein
the information recording medium further comprises a control information recording area to record therein point defining information for defining the one point, and said defect management information generating device generates or updates the defect management information on the basis of the point defining information.

10. The recording apparatus according to claim 7, further comprising: a first recording control device for controlling said recording device to record the defect management information into said temporary defect management area if said defect management information generating device generates or updates the defect management information.

11. The recording apparatus according to claim 7, wherein
the recording apparatus further comprises a defect management information obtaining device for reading the defect management information from said temporary defect management area of the information recording medium on which the defect
management information is recorded in said temporary defect management area,
said defect management information generating device updates the defect management information read by said defect management information obtaining device when said recording device records the record data into said data area, and
said first recording control device controls said recording device to record the defect management information into said temporary defect management area when the defect management information is updated.

12. The recording apparatus according to claim 7, wherein
the information recording medium further comprises a control information recording area to record therein information for controlling at least one of operations of recording and reading in said data area, said control information recording area including a definite defect management area to record therein defect management information of said data area, and
said recording apparatus further comprises:
a finalize command device for giving a command to finalize the information recording medium; and
a second recording control device for controlling said recording device to record the generated or updated defect management information into said definite defect management area when finalize command device gives a command to finalize the information recording medium.

13. A recording method in a recording apparatus for recording record data onto an information recording medium comprising: (i) a data area to record therein record data; (ii) a spare area to record therein evacuation data which is record data to be recorded at a position of a defect in said data area or which is record data recorded at the position; and (iii) a temporary defect management area to temporarily record therein defect management information including at least an evacuation source address which is an address of the position and an evacuation destination address which is an address of a recording position of the evacuation data,
said recording method comprising:
a defect management information generating process of generating or updating the defect management information; and
a recording process of recording at least one of the record data, the evacuation data, and the generated or updated defect management information,
said defect management information generating process generating the evacuation destination address which is specified by a first offset address based on one predetermined point in said spare area, to thereby generate or update the defect management information.

14. A reproducing apparatus for reproducing the record data recorded on an information recording medium comprising: a data area to record therein record data; a spare area to record therein evacuation data which is record data to be recorded at a position of a defect in said data area or which is record data recorded at the position; and a temporary defect management area to temporarily record therein defect management information including at least an evacuation source address which is an address of the position and an evacuation destination address which is an address of a recording position of the evacuation data, the evacuation destination address being specified by a first offset address based on one predetermined point in said spare area,
said reproducing apparatus comprising:
a storing device;
a first reading device for reading the defect management information recorded in said temporary defect management area and storing the read defect management information into said storing device; and
a reproducing device for reproducing the record data recorded in said data area or the evacuation data recorded in said spare area, on the basis of the defect management information stored in said storing device,
said reproducing device calculating the evacuation destination address on the basis of the first offset address.

15. A reproducing method in a reproducing apparatus for reproducing record data recorded on an information recording medium comprising: a data area to record therein record data; a spare area to record therein evacuation data which is record data to be recorded at a position of a defect in said data area or which is record data recorded at the position; and a temporary defect management area to temporarily record therein defect management information including at least an evacuation source address which is an address of the position and an evacuation destination address which is an address of a recording position of the evacuation data, the evacuation destination address being specified by a first offset address based on one predetermined point in said spare area,
said reproducing method comprising:
a first reading process of reading the defect management information recorded in said temporary defect management area; and
a reproducing process of reproducing the record data recorded in said data area or the evacuation data recorded in said spare area, on the basis of the read defect management information,
said reproducing process calculating the evacuation destination address on the basis of the first offset address.

16. A computer program product for recording control to control a computer disposed in a recording apparatus, to make the computer function as at least one portion of a defect management information generating device and a recording device,
said recording apparatus for recording record data onto an information recording medium comprising: (i) a data area to record therein record data; (ii) a spare area to record therein evacuation data which is record data to be recorded at a position of a defect in said data area or which is record data recorded at the position; and (iii) a temporary defect management area to temporarily record therein defect management information including at least an evacuation source address which is an address of the position and an evacuation destination address which is an address of a recording position of the evacuation data,
said recording apparatus comprising:
said defect management information generating device for generating or updating the defect management information; and
said recording device for recording at least one of the record data, the evacuation data, and the generated or updated defect management information,
said defect management information generating device generating the evacuation destination address which is specified by a first offset address based on one predetermined point in said spare area, to thereby generate or update the defect management information.

17. A computer program product for reproduction control to control a computer disposed in a reproducing apparatus, to make the computer function as at least one portion of a first reading device and a reproducing devices
said reproducing apparatus for reproducing record data recorded on an information recording medium comprising: a data area to record therein record data; a spare area to record therein evacuation data which is record data to be recorded at a position of a defect in said data area or which is record data recorded at the position; and a temporary defect management area to temporarily record therein defect management information including at least an evacuation source address which is an address of the position and an evacuation destination address which is an address of a recording position of the evacuation data, the evacuation destination address being specified by a first offset address based on one predetermined point in said spare area,
said reproducing apparatus comprising:
storing device;
said first reading device for reading the defect management information recorded in said temporary defect management area and storing the read defect management information into said storing device; and
said reproducing device for reproducing the record data recorded in said data area or the evacuation data recorded in said spare area, on the basis of the defect management information stored in said storing device,
said reproducing device calculating the evacuation destination address on the basis of the first offset address.

18. A data structure comprising:
a data area to record therein record data;
a spare area to record therein evacuation data which is record data to be recorded at a position of a defect in said data area or which is record data recorded at the position; and
a temporary defect management area to temporarily record therein defect management information including at least an evacuation source address which is an address of the position and an evacuation destination address which is an address of a recording position of the evacuation data,
the evacuation destination address being specified by a first offset address based on one predetermined point in said spare area.
